(19) United States
(12) Patent Application Publication
(10) Pub. No.: US 2026/0312293 A1
(43) Pub. Date: Oct. 8, 2026

(54) SYSTEM AND METHOD FOR ADAPTIVE ARTIFICIAL INTELLIGENCE SELECTION AT A RECONFIGURABLE METASURFACE DEVICE FOR OPTIMIZING WIRELESS THROUGHPUT AND PREDICTIVE MAINTENANCE

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/169,670

(22) Filed: Apr. 3, 2025

(51) Int. Cl. H01Q 15/00; H01Q 3/34; H04B 17/391

(52) U.S. Cl. CPC H01Q 15/0086; H01Q 3/34; H04B 17/3912

(57) ABSTRACT

A system and method of adaptively enhancing a communication system within a wireless network at a reconfigurable metasurface unit cell array includes with a hardware metasurface controller receiving RSSI data, SINR data, and metasurface environment operating data for wireless network data, tasks executed via the wireless network, and physical environment of the radiofrequency environment. The hardware metasurface controller executes machine readable code instructions of an inference engine module to, based on the RSSI data, the SINR data, and the metasurface environment operating data, select among a plurality of machine learning algorithms to control when the metasurface controller dynamically alters phase shifting of one or more metasurface unit cells of the reconfigurable unit cell array to dynamically adjust beamform reflected radiofrequency signals in directionality lobes in the radiofrequency environment and transmission and reception levels of transmitting or receiving antennas to optimize wireless network performance within the radiofrequency environment.

### FIELD OF THE DISCLOSURE

The present disclosure generally relates to a system and method of adaptively enhancing a communication system. More specifically, the present disclosure relates to a system and method of adaptively enhancing a communication systems for wireless information handling systems in a radiofrequency environment using a reconfigurable metasurface unit cell array that selects among a plurality of machine learning algorithms to control how the reconfigurable metasurface device operates within the radiofrequency environment.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used with a wireless interface adapter to transmit and receive wireless communications with other wireless devices in a radiofrequency environment.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system and a reconfigurable metasurface unit cell array comprising a plurality of metasurface unit cells operatively controlled by a metasurface controller that selects among a plurality of machine learning modules to dynamically adjust transmission and reception levels within a wireless network to optimize wireless network performance within a radiofrequency environment according to an embodiment of the present disclosure;

FIG. 2 is a block diagram illustrating a plurality of information handling systems and a reconfigurable metasurface unit cell array comprising a plurality of metasurface unit cells operatively controlled by a metasurface controller that selects among a plurality of machine learning modules to dynamically adjust transmission and reception levels to optimize wireless network performance within a radiofrequency environment according to another embodiment of the present disclosure;

FIG. 3A is a top view graphic diagram showing one of a plurality of metasurface unit cell subgroups of metasurface unit cells of a reconfigurable metasurface unit cell array according to an embodiment of the present disclosure;

FIG. 3B is a perspective view graphic diagram one of a plurality of metasurface unit cell subgroups of metasurface unit cells of a reconfigurable metasurface unit cell array according to another embodiment of the present disclosure;

FIG. 4 is an exploded perspective view graphic diagram showing one of a plurality of metasurface unit cell subgroups of metasurface unit cells of a reconfigurable metasurface unit cell array according to another embodiment of the present disclosure;

FIG. 5 is a top view graphic diagram showing a reconfigurable metasurface unit cell array with an exploded view of one of a plurality of metasurface unit cell subgroups used to detect angle-of-arrival (AoA) of a wireless transmission within the wireless network and determine an appropriate angle-of-departure (AoD) for those wireless transmissions reflected by the reconfigurable metasurface unit cell array in a radiofrequency environment according to an embodiment of the present disclosure;

FIG. 6 is a swimlane flow diagram showing a method of adaptively enhancing wireless communications within a radiofrequency environment at a reconfigurable metasurface unit cell array via selection among a plurality of machine learning modules and execution to dynamically adjust transmission and reception levels according to an embodiment of the present disclosure; and

FIG. 7 is a flow diagram of a method of adaptively enhancing wireless communications within a radiofrequency environment at a reconfigurable metasurface unit cell array via selection among a plurality of machine learning modules and execution to dynamically adjust transmission and reception levels according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Wireless devices may include wirelessly enabled information handling systems, access point devices, or any computing device, such as internet of things (IoT) devices, that are wirelessly capable. As data transmission requirements increase, the electromagnetic (EM) wave (e.g., 5G technologies using 20 to 50 GHz wireless signals or other frequencies, or WiFi 6 signals at 2.4 GHz, 5 GHz or even 6 GHz) used to transmit these ever-increasing amounts of data are shortened or may benefit from extended range, for example, to reach around radiofrequency barriers such as walls. With reconfigurable intelligent surfaces, also known as metasurfaces in the present embodiments, these higher frequencies may be relayed around objects such as walls in order to extend the range of these relatively higher transmission wavelengths by reflecting the wireless transmissions off of its surface. However, these radiofrequency environments can get highly congested with multiple network devices competing for channel allocation and bandwidth within the wireless networks therein. In some instances, certain network devices may need to be prioritized based on the user's role such as a doctor in a hospital wireless network or a security professional in a mall wireless network. Further, physical challenges may occur due to difficult or dynamic physical environments, such as chemical or manufacturing environments, which may make placement, movement, or operation of wireless devices and communications with those wireless devices challenging in a radiofrequency environment.

The present specification describes embodiments of a system and method of adaptively enhancing wireless communications of one or more wireless network communication systems within a radiofrequency environment at a metasurface unit cell array. In an embodiment, the reconfigurable metasurface unit cell array may include a hardware metasurface controller, a metasurface memory device, and a metasurface power management unit (PMU) to provide power to the hardware metasurface processor and memory device. In an embodiment, the hardware metasurface controller may include a neural processing unit (NPU), or can have an additional NPU hardware processing device, that can execute a plurality of machine learning algorithms. The metasurface controller with the NPU may dynamically select among plurality of types of machine learning algorithms based on, for example, the different types of input data that can be processed more effectively or efficiently by a given machine learning algorithm, the specific task requirements of a wireless network in a radiofrequency environment by the reconfigurable metasurface unit cell array, the operational and physical environment including the wireless network environment metrics of the radiofrequency environment with the reconfigurable metasurface unit cell array, and the scalability and complexity of the wireless networks in the radiofrequency environment. The metasurface controller with the NPU may execute machine readable code instructions of a wireless network feature extraction module and an inference engine module to dynamically select among these plurality of available types of machine learning algorithms at the reconfigurable metasurface unit cell array based on various inputs as above. In an embodiment, the reconfigurable metasurface unit cell array may manipulate electromagnetic (EM) waves of incident radiofrequency signals received within a wireless network of the radiofrequency environment. The reconfigurable metasurface unit cell array includes a plurality of metasurface unit cells with subsets of those metasurface unit cells determining angle-of-arrival (AoA) for those radiofrequency signals and providing for adjustment to angle-of-departure (AoD) via adjustments the reflected EM waves. During operation, the hardware metasurface controller with the NPU may execute machine readable code instructions of the feature extraction module to detect wireless network features associated with wireless communications within the radiofrequency environment.

During operation, the hardware metasurface controller with the NPU may further execute machine readable code instructions of the inference engine module to, based on the RSSI data, the SINR data, wireless network type data, and wireless features, as well as inputs of the physical environment and tasks of the wireless networks for a radiofrequency environment select among a plurality of machine learning (ML) algorithms. The selection of the appropriate machine learning algorithms may be done so as to control when the metasurface PMU alters power to any of the plurality of RF antennas for wireless devices to dynamically adjust transmission and reception levels within the wireless network and adjustments to the reconfigurable metasurface unit cell array to adjust reflected EM waves of the radiofrequency signals for gain or directionality within the radiofrequency environment to optimize wireless network performance within the radiofrequency environment.

In an embodiment, the wireless features of a radiofrequency environment with respect to the reconfigurable metasurface unit cell array may also include the AoA and current AoD or radiofrequency signals reflected via the reconfigurable metasurface unit cell array that defines how to optimize beamforming patterns, interference mitigation, and spatial filtering of wireless network radiofrequency signals within the radiofrequency environment. In an embodiment, by detecting the AoA data, the reconfigurable metasurface unit cell array may intelligently select and switch between ML algorithms for real-time network adaptation and beamforming optimization in a dynamically changing radiofrequency environment with changing congestion levels, user prioritizations, or challenging physical environmental factors.

Because the reconfigurable metasurface unit cell array is reconfigurable, the present specification contemplates any type of reconfigurable metasurface unit cell array. In an embodiment, the metasurface controller may send a bias voltage to an attenuator circuit to adjust the amplitude of the reflected radiofrequency signal at any of a plurality of metasurface unit cells within a metasurface unit cell subgroup of the reconfigurable metasurface unit cell array to adjust a level of constructive or destructive interference to the EM waves of the incident radiofrequency signal created by phase adjustment operation of a tunable delay circuit of the reconfigurable metasurface unit cell array. In an embodiment, the metasurface controller may send a bias voltage to a tunable delay circuit to phase shift the captured, incident radiofrequency signal to generate a reflected radiofrequency signal relative to a second metasurface unit cell for interference patterns in the incoming EM waves of the incident radiofrequency signal to create directional EM wave radiofrequency transmission or reception lobes within the reflected EM waves of the incident radiofrequency signal. In an embodiment, the reconfigurable metasurface unit cell array, each metasurface unit cell subgroup, or each unit cell of the reconfigurable metasurface unit cell array may include a signal matching circuit operatively coupled to each of the microwave circuits of the plurality of metasurface unit cells to match the impedance received from each of a plurality of microwave circuits prior to feeding the captured, incident radiofrequency signal to a tunable delay circuit for phase shifting of reflected EM waves. These devices allow the reconfigurable metasurface unit cell array to engage in beamforming using constructive and/or destructive EM wave principles across plural metasurface unit cells in a subgroup or among plural subgroups in various embodiments. This also, when necessary, allows the metasurface controller to determine, based on detected RSSI and SINR values among other wireless network characteristics and physical environment inputs, when to provide more power to the plurality of RF antennas, allocate various channels within the wireless network, and prioritize various network devices (e.g., information handling system) in order to maintain sufficient wireless connection and coverage within the wireless network for the dynamically-changing wireless devices and for the physical environmental challenges within the radiofrequency environment of the reconfigurable metasurface unit cell array.

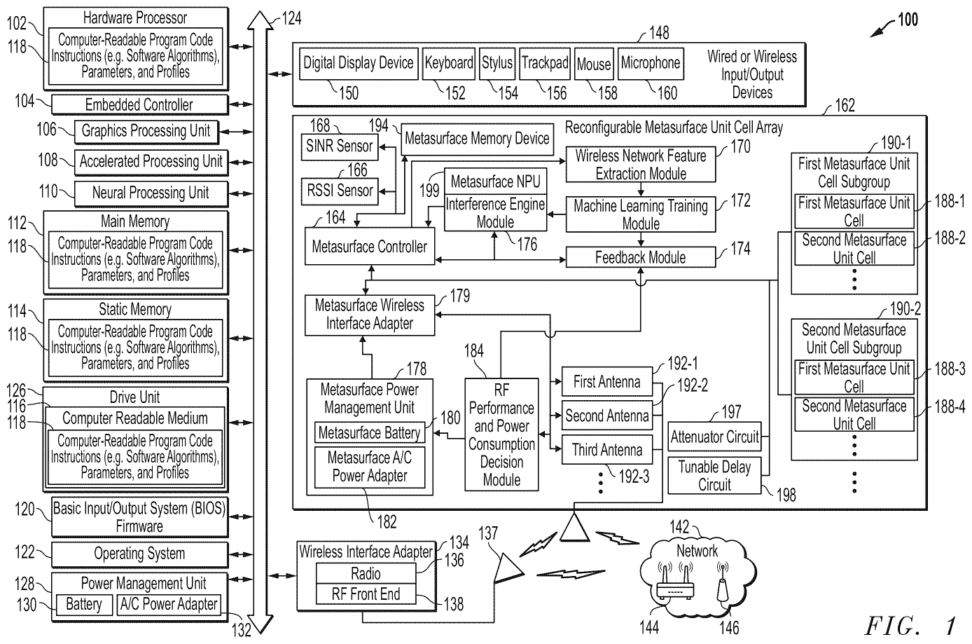

Turning now to the figures, FIG. 1 illustrates an information handling system 100 similar to the information handling systems according to several aspects of the present disclosure that may operate as a source or target radiofrequency device for wirelessly interfacing with the reconfigurable metasurfaces of the embodiments of the present disclosure. It is appreciated that terms such as “metasurface unit cell array” or “reconfigurable metasurface unit cell array” are meant to be understood as a metasurface that includes a plurality of reconfigurable unit cells that operate together to engage in, at least, reflecting, beamforming, and transmission of EM waves. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable code instructions stored in static memory 114, main memory 112, or drive unit 126 may be involved in invoking such machine readable code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable code instructions (e.g., software algorithms) parameters, and profiles 118 that may operate on servers or systems, remote data centers, or on-box in individual client information handling systems according to various embodiments herein. In some embodiments, it is understood any or all portions of machine readable code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and one or more antennas 137 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems. In the context of the present disclosure the one or more antennas 137 may include one or more WiFi antennas operating at 2.4 GHz, 5 GHz, and/or 6 GHz frequencies, one or more Bluetooth antennas, and one or more 5G new radio (5G-NR) antennas that operate at Frequency Range 1 (FR1) (which includes sub-7 GHz frequency bands and those from 410 MHz to 7125 MHz 0 and Frequency Range 2 (FR 2) (which includes frequency bands from 24.25 GHz to 71.0 GHz frequency bands). It is appreciated that the one or more antennas 137 may support any frequency or frequency range and the present specification appreciates the use of these other types of antennas 137.

In other embodiments, the wireless interface device 134 with its radio 136, RF front end 138 and antennas 137 are used to communicate with a WWAN or WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 137 and other circuitry of the radio 136 such as one or more antenna ports used for wireless communications via multiple radio access technologies (RATs) of wireless networks in a radiofrequency environment. The radio 136 may communicate with one or more wireless technology protocols. It is appreciated that the information handling system 100 may wirelessly communicate with a target receiver device 178 via the reconfigurable metasurface unit cell array 162 in a radiofrequency environment. The receiver device 178 may be any other device and may include the AP 144, the base station 146, or any other computing device in the radiofrequency environment described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine readable code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes machine readable code instructions, parameters, and profiles 118 or receives and executes machine readable code instructions, parameters, and profiles 118 responsive to a propagated signal, so that a hardware device connected to a network 142 may communicate voice, video, or data over the network 142. Further, the machine readable code instructions, parameters, and profiles 118 may be transmitted or received over the network 142 via the network interface device or wireless interface adapter 134.

The information handling system 100 may include a set of machine readable code instructions, parameters, and profiles 118 that may be executed to cause the computer system to perform any one or more of the methods or computer-based functions disclosed herein. For example, machine readable code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable code instructions, parameters, and profiles 118 may be coordinated by an operating system (OS) 122, and/or via an application programming interface (API) include a unified device API described herein. An example OS 122 may include Windows ®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may be one of many such wireless devices within a radiofrequency environment. In an embodiment, the information handling system 100 may initiate wireless transmissions via a wireless interface adapter as described herein. As such, the information handling system 100 may implement the reconfigurable metasurface unit cell array 162 such that the reconfigurable metasurface unit cell array 162 can relay those wireless transmissions to a receiving device such as an access point 144 or another network device in the radiofrequency environment. In an embodiment, the reconfigurable metasurface unit cell array 162 may be affixed to a surface within the wireless network such that wireless transmissions may be reflected off of the surface of the reconfigurable metasurface unit cell array 162. In other embodiments, the reconfigurable metasurface unit cell array 162 may be a standalone reconfigurable metasurface unit cell array 162 that operates as a wireless device within a radiofrequency environment and may communicate with information handling systems 100 or other wireless devices in a radiofrequency environment via a metasurface wireless interface adapter 179.

The reconfigurable metasurface unit cell array 162 may, in an embodiment, include a metasurface power management unit (PMU) 178. The metasurface PMU 178 may be a power source used to power the devices, circuits, and elements operatively coupled to and/or formed onto the reconfigurable metasurface unit cell array 162. In an embodiment, the metasurface PMU 178 may include a metasurface battery 180 that is used by the metasurface PMU 178 to power, with low power, those devices. Alternatively, and in another embodiment, the metasurface PMU 178 may include a metasurface A/C power adapter 182 that regulates power received from an A/C power source. Again, the reconfigurable metasurface unit cell array 162 including the devices, circuits, and elements operatively coupled to and/or formed onto the reconfigurable metasurface unit cell array 162 require low power for operation according to some embodiments herein. In some embodiments, where the reconfigurable metasurface unit cell array 162 is not standalone but instead part of or installed on an information handling system 100, the PMU 120 of the information handling system 100 may provide power to the reconfigurable metasurface unit cell array 162.

In an embodiment, the reconfigurable metasurface unit cell array 162 includes a plurality of metasurface unit cells 188-1, 188-2, 188-3, 188-4 shown in FIG. 1 to include, at least, a first metasurface unit cell 188-1, a second metasurface unit cell 188-2, a third metasurface unit cell 188-3, and a fourth metasurface unit cell 188-4. It is appreciated, however, that the reconfigurable metasurface unit cell array 162 may include more than the first metasurface unit cell 188-1, second metasurface unit cell 188-2, third metasurface unit cell 188-3, and fourth metasurface unit cell 188-4 shown in FIG. 1. In an embodiment, the reconfigurable metasurface unit cell array 162 may include an array of metasurface unit cells 188-1, 188-2, 188-3, 188-4 arranged in rows and columns within, for example, a metasurface unit cell subgroup 190-1, 190-2 with the reconfigurable metasurface unit cell array 162, each that may include a nine by nine array of metasurface unit cells 188-1, 188-2, 188-3, 188-4. It is appreciated, however, that any arrangement and any number of metasurface unit cells 188-1, 188-2, 188-3, 188-4 may be used to form the reconfigurable metasurface unit cell array 162 described herein. As shown in FIG. 1, an example of these metasurface unit cell subgroups 190-1, 190-2 includes the first metasurface unit cell 188-1 and second metasurface unit cell 188-2 among a plurality of metasurface unit cells that form the first metasurface unit cell subgroup 190-1 with the third metasurface unit cell 188-3 and fourth metasurface unit cell 188-4 being two of a plurality of metasurface unit cells that form a second metasurface unit cell subgroup 190-2. In an embodiment, each metasurface unit cell subgroup 190-1, 190-2 may include nine metasurface unit cells 188-1, 188-2, 188-3, 188-4 with each metasurface unit cell subgroup 190-1, 190-2 being operatively coupled to a metasurface controller 178 that controls the operation of each of the metasurface unit cell subgroup 190-1, 190-2 and, in an embodiment, each metasurface unit cell 188-1, 188-2, 188-3, 188-4 individually.

In an embodiment, each metasurface unit cells 188-1, 188-2, 188-3, 188-4 may be operatively controlled by the metasurface controller 164. In order to control the operation of each of the metasurface unit cells 188-1, 188-2, 188-3, 188-4 and/or a subgroup of metasurface unit cells 188-1, 188-2, 188-3, 188-4 within the reconfigurable metasurface unit cell array 162, the metasurface controller 164 may control the operation of a signal matching circuit, one or more attenuator circuits 197, or one or more tunable delay circuits 198 in various embodiments. For ease of understanding, the operation of the metasurface controller 164, attenuator circuits 197, and tunable delay circuits 198 will be described as controlling a single metasurface unit cell subgroup 190-1, 190-2 within the reconfigurable metasurface unit cell array 162. It is appreciated, however, that the metasurface controller 164 may control the operation of a single attenuator circuit 197 and tunable delay circuit 198 for a metasurface unit cell subgroup 190-1, 190-2 among a plurality of metasurface unit cell subgroup 190-1, 190-2 of metasurface unit cells 188-1, 188-2, 188-3, 188-4 within the reconfigurable metasurface unit cell array 162 in various embodiments.

In an embodiment, each metasurface unit cell 188-1, 188-2, 188-3, 188-4 may be operatively controlled by the metasurface controller 164. Various types of reconfigurable metasurface unit cells 188-1, 188-2, 188-3, 188-4 may be used with a reconfigurable metasurface unit cell array including metasurface unit cells 188-1, 188-2, 188-3, 188-4 with adjustable resonant structures formed phase change material on a substrate. In other embodiments, the resonant structures may be relatively static. However, in order to control the operation of each of the metasurface unit cells 188-1, 188-2, 188-3, 188-4 and/or a metasurface unit cell subgroup 190-1, 190-2 within the reconfigurable metasurface unit cell array 162, the metasurface controller 164 may control the operation of a signal matching circuit, one or more attenuator circuits 197, or one or more tunable delay circuits 198 in various embodiments. For ease of understanding, the operation of the metasurface controller 164, attenuator circuit 197, and tunable delay circuit 198 will be described as controlling a single metasurface unit cell subgroup 190-1, 190-2 within the reconfigurable metasurface unit cell array 162. It is appreciated, however, that the metasurface controller 164 may control the operation of a single attenuator circuit 197 and tunable delay circuit 198 for a metasurface unit cell subgroup 190-1, 190-2 among a plurality of subgroups of metasurface unit cells 188-1, 188-2, 188-3, 188-4 within the reconfigurable metasurface unit cell array 162 in various embodiments.

In some embodiments, each of the metasurface unit cells 188-1, 188-2, 188-3, 188-4 may include passive concentric circular resonating antennas or resonant structures that are formed of a dimension and separated by dimensions that resonate with incident EM waves of particular radiofrequencies for radiofrequency communications. Those EM waves of radiofrequency communications are propagated omnidirectionally from one or more of the antennas 192-1, 192-2, 192-3 of wireless devices in a radiofrequency environment. In some embodiments, the one or more of the antennas 192-1, 192-2, 192-3 may be formed on a periphery of reconfigurable metasurface unit cell array 162 or nearby the reconfigurable metasurface unit cell array 162 such as a reconfigurable metasurface unit cell array 162 formed on or operatively coupled with an information handling system 100 in some embodiments. The incident EM waves may be received from these periphery one or more of the antennas 192-1, 192-2, 192-3 or received from other wireless devices in the radiofrequency environment. The metasurface unit cells 188-1, 188-2, 188-3, 188-4 may include a conductive fixed tab within the concentric circular antennas or concentric resonant structures in an embodiment. Further, while concentric circular antennas or resonant structures are discussed in embodiments herein, any shape of concentric antennas or resonant structures for the passive resonant structure portions of the metasurface unit cell 188-1, 188-2, 188-3, 188-4 may be used. These passive concentric circular resonating antennas of the metasurface unit cells 188-1, 188-2, 188-3, 188-4 may receive those incident EM waves and transfer the EM wave resonance through a coupler to a microwave circuit placed below the passive concentric circular resonating antennas or structures of each metasurface unit cell 188-1, 188-2, 188-3, 188-4. The microwave circuit of each metasurface unit cell 188-1, 188-2, 188-3, 188-4 acts as the processing units that manipulate the captured EM wave energy via input from the passive concentric circular resonating antennas and couplers to phase shift these captured EM waves and synthesize a unified waveform for propagation back to or reflection across plural the metasurface unit cells 188-1, 188-2, 188-3, 188-4 in reconfigurable metasurface unit cell array 162.

In an embodiment, one or more impedance match junctions between each of the microwave circuits may be used to direct those signals from each microwave circuit to a signal matching circuit that optimizes signal flow into other processing elements of the microwave circuit for one or more of the metasurface unit cells 188-1, 188-2, 188-3, 188-4 of the reconfigurable metasurface unit cell array 162 described herein. In an embodiment, the signal matching circuit ensures that optimal impedance alignment as energy flows from the microwave circuits. In an embodiment, the signal matching circuit refines impedance alignment thereby enhancing the signal quality from each of the microwave circuits of each of the metasurface unit cells 188-1, 188-2, 188-3, 188-4, thereby minimizing potential power losses during transmission and reflection of the EM waves for radiofrequency signal in the radiofrequency environment.

After the impedance of each signal from each of the microwave circuits has been matched, the signal may be compared at the attenuator circuit 197 and tunable delay circuit 198 to a bias reference input operatively coupled to the metasurface controller 164. In an embodiment, the bias reference input voltage or signal is received as input to the attenuator circuit 197 and the tunable delay circuit 198 to control or change the attenuation level or phase-shift level of the captured, incident radiofrequency signal EM wave received from the signal matching circuit. In an embodiment, the bias reference input is an actuation voltage for adjustment to tunable components such as the attenuator circuit 197 and the tunable delay circuit 198 for selection of attenuation applied to or a plurality of phase-shift levels applied to the incoming captured, radiofrequency signal from the signal matching circuit with the phase characteristics and amplitude defined by the bias reference input. The tunable delay circuit 198 may apply a phase shift to the signal so as to align or oppose the phase of the wavefronts of the emitted and reflected signals across plural metasurface unit cells 188-1, 188-2, 188-3, 188-4 thereby contributing to constructive or destructive interference patterns created at the reconfigurable metasurface unit cell array 162 for reflected EM waves of the radiofrequency signals. In an embodiment, the attenuator circuit 197 also adjusts the amplitude of the incoming signal from the signal matching circuit from the bias reference input. The bias reference input is a voltage level that may switch switchable elements to dictate matching of amplitudes to generate gain in reflected EM waves or dictate the attenuation level needed to achieve the desired signal strength reduction for other radiofrequency signal components such as for a generated null region.

During operation, the metasurface controller 164 may receive data describing wireless transmissions from one or more wireless networks and other wireless network data of the radiofrequency environment. In an embodiment, the hardware metasurface controller 164 may receive a received signal strength indicator (RSSI) data, signal-to-noise-ratio (SINR) data, angle-of-arrival (AoA) data, and wireless network type data of wireless network communication signals in the radiofrequency environment. The RSSI data may be received from an RSSI sensor 166 that is operatively coupled to the metasurface controller 164 on the reconfigurable metasurface unit cell array 162 in an embodiment. The SINR data may also be received from an SINR sensor 168 also operatively coupled to the metasurface controller 164 in an embodiment. In other embodiments, RSSI data and SINR data may be received from one or more pairs of wirelessly communicating wireless devices within a wireless network.

It is appreciated that other wireless network and wireless transmission data may be received by the metasurface controller 164 such as the AoA data. For example, during operation of the reconfigurable metasurface unit cell array 162, the microwave circuits may perform additional tasks such as determining this AoA of any given EM waves of wireless transmissions incident on the reconfigurable metasurface unit cell array 162. In an embodiment, the passive concentric circular resonating antennas of the metasurface unit cells 188-1, 188-2, 188-3, 188-4 may receive those incident EM waves and transfer the EM wave resonance through a coupler and to the microwave circuit placed below the passive concentric circular resonating antennas of each metasurface unit cell 188-1, 188-2, 188-3, 188-4. The known spacing of the metasurface unit cells 188-1, 188-2, 188-3, 188-4 from one another and their concentric circular resonating antennas may determine a delay of reception of incoming incident EM waves of a particular radiofrequency signal. The microwave circuit of each metasurface unit cell 188-1, 188-2, 188-3, 188-4 act as the processing units that can detect from this delay and known spacing among metasurface unit cells 188-1, 188-2, 188-3, 188-4, in a subgroup for example, this AoA of the incident EM waves and send that data to the metasurface controller 164 for further processing as described herein.

As the metasurface controller 164 receives the RSSI data, the SINR data, and the AoA data, the metasurface controller 164 may execute machine readable code instructions of a wireless network feature extraction module 170. Other radiofrequency environment data may also be provided, such as wireless network congestion, number of active wireless devices, among other factors. The execution of the wireless network feature extraction module 170 provides, as output, various data describing conditions present within one or more wireless networks in a radiofrequency environment. For example, this data may include detected fluctuations that indicate interference, attenuation, or weak connectivity areas within the wireless network, averaged, peak, and threshold-based metrics indicative of traffic within the wireless network, interference sources within the wireless network, and prioritized network devices within the wireless network, among other data. This output from the wireless network feature extraction module 170 may be used by one of a plurality of machine learning (ML) models that provide data describing how the reconfigurable metasurface unit cell array 162 is to adaptively enhance wireless communications within the wireless network. Further, the metasurface controller 164 may utilize output of the wireless network and radiofrequency environment inputs as part of a plurality of inputs to select a machine learning (ML) model for execution by the metasurface controller 164 from among plural available machine learning models appropriate for the radiofrequency environment, tasks to be accomplished by wireless devices therein, congestion and prioritization of communications, and physical environment challenges.

In an embodiment, the output from the wireless network feature extraction module 170 may be provided to a machine learning (ML) training module 172. The ML training module 172 may receive, as input, the RSSI data, the SINR data, the AoA data, and various data describing conditions present within the wireless network or wireless networks of the radiofrequency environment that includes wireless network type data and wireless features as described herein in order to train one or more ML algorithms. These ML algorithms may include any type of ML algorithms including supervised learning algorithms, unsupervised learning algorithms, and reinforcement learning algorithms, deep learning algorithms, recurrent neural network algorithms, conventional neural network (CNN) algorithms, long short-term memory (LSTM) network algorithms, and ensemble algorithms that combine one or more of these types of ML algorithms. It is appreciated that these plurality of types of ML algorithms may each be best suited to serve a specific or tailored purpose. For example, some ML algorithms may be better suited for diverse data types and features such as a CNN algorithm that is best suited for visual data while a LSTM network algorithm may be best suited for sequential data. For specialized task requirements at the reconfigurable metasurface unit cell array 162, an ML algorithm focused on anomaly detection and a ML algorithm focused on resource allocation and real-time decision-making requirements may be used. Still further, in some example embodiments where environmental variability is a concern or is detected within the wireless network, a single ML algorithm may not be flexible enough to adapt to changes within the wireless network and, therefore, an ensemble ML algorithm may be used with the metasurface controller 164 executing machine readable code instructions of a plurality of ML algorithms described above based on those changes in the wireless network.

Additionally, some wireless network environments may benefit from modularity, where different ML algorithms being used to handle different aspects of the reconfigurable metasurface unit cell array 162 and antennas 192-1, 192-2, 192-3 for particular tasks to improve wireless communications in the radiofrequency environment. This modular approach for selectability among plural ML algorithms to be executed also allows for easier updates and scalability as new ML algorithms are added or replaced. Having multiple ML algorithms uploaded to a metasurface memory device 194 and executable by the metasurface controller 164 can provide redundancy thereby improving the reliability of the metasurface controller 164 to detect changes and adaptively enhance communications with the wireless network. If one ML algorithm fails to accommodate for any detected anomalies within a wireless network of a radiofrequency environment or performs poorly in enhancing communication with the wireless network in a radiofrequency environment, other ML algorithms may be executed that can help compensate for a first execute ML algorithm that does not sufficiently address wireless network issues. In this way, intelligent selection among a plurality of available ML algorithms for control of different aspects of the reconfigurable metasurface unit cell array 162 and antennas 192-1, 192-2, 192-3 may ensuring consistent and accurate operation of the reconfigurable metasurface unit cell array 162 within the radiofrequency environment with dynamically changing conditions. The ML algorithms may optimize different aspects of the reconfigurable metasurface unit cell array 162, such as power consumption, signal quality, and data throughput by using the trained ML algorithms that may allow for more targeted optimization that leads to overall system efficiency. Thus, the execution of the machine readable code instructions of the ML training module 172 by the metasurface controller 164 may cause one or more of these ML algorithms to be trained appropriately such that operation of the reconfigurable metasurface unit cell array 162 within the radiofrequency environment enhances communication within those one or more wireless networks operating within the radiofrequency environment.

Once each of the ML algorithms have been trained using the RSSI data, the SINR data, the AoA data and other wireless network data described herein, the output may be provided to an inference engine module 176. Execution of the machine readable code instructions of the inference engine module 176 by the metasurface controller 164 causes a hardware processor such as a metasurface neural processing unit (NPU) 199, as part of or in addition to the metasurface controller 164, formed on the reconfigurable metasurface unit cell array 162 to execute the machine readable code instructions of one of the plurality of ML algorithms for control of different aspects of the reconfigurable metasurface unit cell array 162 and antennas 192-1, 192-2, 192-3. Thus, once trained by the ML training module 172, one or more ML algorithms may be used by the metasurface controller 164 to change the operating parameters of the reconfigurable metasurface unit cell array 162 such that the reconfigurable metasurface unit cell array 162 adaptively enhances communication within the wireless network of a radiofrequency environment according to requirements and challenges therein.

It is appreciated that the metasurface NPU 199 may, in an embodiment, select among the plurality of trained ML algorithms depending on a detected AoA data of wireless transmissions at the reconfigurable metasurface unit cell array 162. Angle-of-departure (AoD) data that has been extrapolated from the currently set AoD data may also inform the metasurface NPU 199 of directionality and location of various different wireless network devices such as other information handling systems, other reconfigurable metasurface unit cell arrays, APs 144, and base stations 146 within the radiofrequency environment in some embodiments. In an example embodiment, as each of the metasurface unit cells 188-1, 188-2, 188-3, 188-4 is resonated by an incoming EM transmission, a differential delay may be detected between, for example, the first metasurface unit cell 188-1 and the second metasurface unit cell 188-2 having a known spacing. This differential delay (e.g., the period of time taken to detect a specific EM wave at one unit cell versus another having a known spacing from one another) may be calculated and the AoA may be detected. This process may be completed between every metasurface unit cell 188-1, 188-2, 188-3, 188-4 within each metasurface unit cell subgroup 190-1, 190-2 of the reconfigurable metasurface unit cell array 162 such that an AoA associated with each of a plurality of wireless transmissions in a radiofrequency environment may be determined by the metasurface controller 164.

It is also further appreciated that the metasurface NPU 199 may select among the plurality of ML algorithms based on other factors. Other factors may include detected network congestion, data indicating tasks being performed by wireless devices within the radiofrequency environment, data indicating user prioritizations and congestion levels in wireless networks, data indicating physical environment challenges or limitations of a radiofrequency environment, among other factors used by the metasurface NPU 199 for selection of one or more ML algorithms among plural available ML algorithms in embodiments herein. Further, the metasurface NPU 199 may select among the plurality of ML algorithms based on the current processing resources available and the anticipated compute resources consumed by executing the machine readable code instructions of a given ML algorithm in an embodiment. In another example embodiment, the metasurface NPU 199 may select a ML algorithm based on the level of training of each of the ML algorithms such that the best trained ML algorithms are selected over yet-untrained or insufficiently trained ML algorithms. In an embodiment, the metasurface NPU 199 may request that new ML algorithms be transmitted to the reconfigurable metasurface unit cell array 162 when the metasurface NPU 199 determines that the ML algorithms stored on the metasurface memory device 294 are not sufficient.

Where, for example, the metasurface controller 164 determines that the differential delay is consistent, the metasurface controller 164 may select a reinforcement learning ML algorithm as a base ML algorithm. This selection of the reinforcement learning ML algorithm may better optimize network traffic congestion within the wireless network that the reconfigurable metasurface unit cell array 162 has been placed within than would other types of ML algorithms. In an example embodiment where the wireless network environment is dynamic with the AoA, RSSI, SINR, and other dynamic wireless network data changes are detected, the metasurface controller 164 may select a different type of ML algorithm such as a supervised ML algorithm that can be trained to accommodate for these dynamic changes in the radiofrequency environment. It is also appreciated that the metasurface controller 164 may dynamically switch between directing the metasurface NPU 199 to execute the machine readable code instructions of a first ML algorithm to executing the machine readable code instructions of a second ML algorithm based on the changing data received at the metasurface controller 164 or based on the wireless network being adjusted for within the radiofrequency environment. It is also appreciated that the metasurface controller 164 may direct the metasurface NPU 199 to execute the machine readable code instructions of a plurality of ML algorithms that have been amalgamated to customize the operating characteristics of the reconfigurable metasurface unit cell array 162 as well as a plurality of antennas 192-1, 192-2, 192-3 within a radiofrequency environment.

Output from the ML algorithms may result in adjustments of the operation of the reconfigurable metasurface unit cell array 162 in embodiments herein. For example, the metasurface controller 164, based on the output from the various ML algorithms executed by the metasurface NPU 199, may engage in directing that power provided to one or more on-board antennas 192-1, 192-2, 192-3 or, via wireless communication, other wireless network antennas should be increased or reduced for particular radiofrequency signals. For example, the amount of power provided to the one or more on-board antennas 192-1, 192-2, 192-3 (e.g., first antenna 192-1, second antenna 192-2, third antenna 192-3) or to another antenna within the wireless network (e.g., an antenna associated with the AP 144) may be increased in order to increase the signal strength thereby increasing the wireless coverage. This may be done when the ML algorithms have indicated that the SINR is too low or the RSSI value is also too low to support sufficient wireless communication. Also, bias signals to the microwave elements of the reconfigurable metasurface unit cell array 162 may be provided in order to adjust different aspects of the reconfigurable metasurface unit cells 188-1, 188-2, 188-3, 188-4 to beamform and amplify those EM waves received incident to the reconfigurable metasurface unit cell array 162 and reflected or retransmitted forward by the reconfigurable metasurface unit cell array 162. This allows the reconfigurable metasurface unit cell array 162 to amplify reflected EM waves and beamform those EM waves to a location via adjustment to one or more different aspects of the reconfigurable metasurface unit cells 188-1, 188-2, 188-3, 188-4. Again, this beamforming location may be based on an extrapolated AoD of a wireless communication signal to a specific wireless network device in a radiofrequency environment relative to the reconfigurable metasurface unit cell array 162 detected by the metasurface controller 164.

Thus, where power adjustments to the on-board antennas 192-1, 192-2, 192-3 and/or adjustments to the microwave circuits of the reconfigurable metasurface unit cell array 162 are necessary, the metasurface controller 164 may execute machine readable code instructions of an RF performance and power consumption decision module 184 in order to determine to what degree the power provided should be altered to antennas 192-1, 192-2, 192-3 or bias signals sent to alter different aspects of the reconfigurable metasurface unit cell array 162.

It is appreciated that any of this data from the output of the ML algorithms by the metasurface NPU 199 may be shared with any other network device in some embodiments. In an embodiment, the metasurface controller 164 may direct that the metasurface wireless interface adapter 179 control any of the on-board antennas 192-1, 192-2, 192-3 to transmit this data to any other network device that may benefit from the output data from the ML algorithms in order to enhance communication within the wireless network based on conditions or requirements of the radiofrequency environment.

In an embodiment, a feedback module 174 may also be included on the reconfigurable metasurface unit cell array 162 to provide the metasurface controller 164 with input related to the suggested operational changes that should be made to the reconfigurable metasurface unit cell array 162. In an embodiment, the metasurface controller 164 may receive this data and perform those actions as suggested by the operation of the metasurface NPU 199. Additionally, the feedback module 174 may provide input to the metasurface controller 164 related to the outcome of those processes executed by the RF performance and power consumption decision module 184. In an example embodiment, the RF performance and power consumption decision module 184 may perform power regulation functions as described herein and the feedback module 174 may relay this data to the metasurface controller 164. This data may be compared with current RSSI data and SINR data received by the metasurface controller 164 in order to determine if those actions carried out by the RF performance and power consumption decision module 184 increased or enhanced communication within the wireless network.

The system and methods described herein provide for a reconfigurable metasurface unit cell array 162 with integrated intelligence in the form of ML algorithms executed by the metasurface NPU 199 in order to optimize wireless throughput and wireless communication within the wireless network. The system and method may dynamically select a best suitable ML algorithm and may select among those ML algorithms based on compute requirements, amount of training for each ML algorithm in one or more wireless network conditions.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

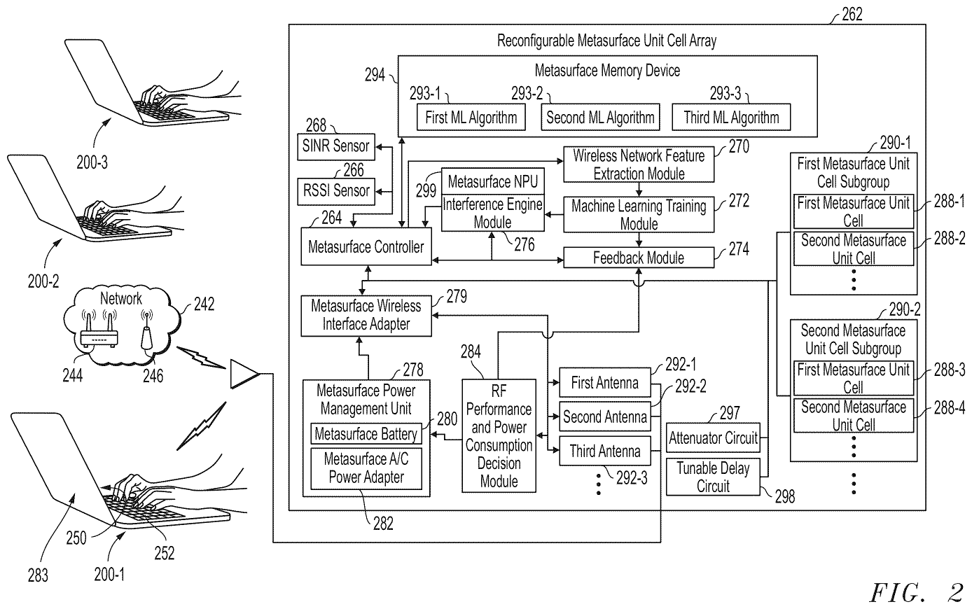

FIG. 2 is a block diagram illustrating a plurality of information handling systems and a reconfigurable metasurface unit cell array comprising a plurality of metasurface unit cells operatively controlled by a metasurface controller that selects among a plurality of machine learning modules to dynamically adjust transmission and reception levels within a radiofrequency environment to optimize wireless network performance according to another embodiment of the present disclosure. FIG. 2 shows the plurality of information handling systems 200-1, 200-2, 200-3 as laptop-type information handling systems 200-1, 200-2, 200-3 that may each include a digital display device 250 and a keyboard 252 as an output and input device, respectively. It is appreciated that those wireless network devices that include these information handling systems 200-1, 200-2, 200-3 may also be any type of information handling system described herein such as the AP 244, base station 246, a smartphone, a tablet, or other types of information handling systems in the radiofrequency environment.

As described herein, the reconfigurable metasurface unit cell array 262 may be used within a wireless network to reflect incoming wireless transmissions off of its surface and around objects. This allows for smaller radio frequencies (RFs) to be used within the radiofrequency environment that can transmit large amounts of data but have a limited range especially through objects. In an embodiment, the reconfigurable metasurface unit cell array 262 include a plurality of metasurface unit cells 288-1, 288-2, 288-3, 288-4 that may be separated into one or more metasurface unit cell subgroups 290-1, 290-2 (e.g., first metasurface unit cell subgroup 290-1, second metasurface unit cell subgroup 290-2, etc.). In one embodiment, the metasurface unit cells 288-1, 288-2, 288-3, 288-4 or their one or more metasurface unit cell subgroups 290-1, 290-2 are controlled by the metasurface controller 264. Any type of reconfigurable metasurface unit cells 288-1, 288-2, 288-3, 288-4 may be used to include resonating antennas or structures formed onto a metasurface substrate with dimension of the metasurface unit cells 288-1, 288-2, 288-3, 288-4 and spacing of the resonating antennas or structures to reflect or phase-shift incoming incident EM waves in the radiofrequency environment. The resonating antennas maybe active or passively reconfigurable with respect to phase-shifting the reflected EM waves in various embodiment and may be controllable by phase-changing material resonating structures, varactors, variable capacitors, or one or more attenuator circuits 297, or one or more tunable delay circuits 298 in various embodiments.

In some embodiments, the metasurface unit cells 288-1, 288-2, 288-3, 288-4 may include reconfigurable resonating antennas or structures some of which may have switchable conductivity, such as formed of phase-changing materials with conductivity switchable by application of heat pulses. The phase-changing materials may include GeTe, SbTe, or GeSbTe among other similar non-volatile phase change materials that switch between a crystalline conductive state or an amorphous dielectric state from a heat pulse, such as from a controllable refractory heater in the metasurface substrate. These reconfigurable resonating antennas or structures may include a portion of conductive material and phase-changing material formed onto a substrate with refractory heaters in the substrate able to switch the conductive or dielectric phase of some of the resonating antennas. This, in turn, may change the phase-shift of such metasurface unit cells 288-1, 288-2, 288-3, 288-4 based on whether phase-change materials of one or more resonating antennas or structures are switched to a conductive state or resonant state which may control beamforming of reflected EM waves of radiofrequency signals by the reconfigurable metasurface unit cell array 262. In an embodiment, the resonating antennas or structures may be concentric rings or of another shape on the metasurface substrate surface of the metasurface unit cells 288-1, 288-2, 288-3, 288-4.

In other embodiments, in order to control the operation of each of the metasurface unit cells 288-1, 288-2, 288-3, 288-4 within the reconfigurable metasurface unit cell array 262, the metasurface controller 264 may control the operation of a signal matching circuit, one or more attenuator circuits 297, or one or more tunable delay circuits 298 in various embodiments. For ease of understanding, the operation of the metasurface controller 264, attenuator circuits 297, and tunable delay circuits 298 will be described as controlling a single metasurface unit cell subgroup 290-1, 290-2 within the reconfigurable metasurface unit cell array 262. It is appreciated, however, that the metasurface controller 264 may control the operation of a single attenuator circuit 297 and tunable delay circuit 298 for each or any grouping of metasurface unit cells 288-1, 288-2, 288-3, 288-4a among a plurality of metasurface unit cell subgroups 290-1, 290-2 of metasurface unit cells 288-1, 288-2, 288-3, 288-4 within the reconfigurable metasurface unit cell array 262 in various embodiments. The metasurface unit cells 288-1, 288-2, 288-3, 288-4 in such an embodiment may include a plurality of passive resonating antennas or structures that may be concentric rings or of another shape on the metasurface substrate surface.

In an embodiment, each metasurface unit cell 288-1, 288-2, 288-3, 288-4 may be operatively controlled by the metasurface controller 264. In order to control the operation of each of the metasurface unit cells 288-1, 288-2, 288-3, 288-4 and/or a metasurface unit cell subgroup 290-1, 290-2 within the reconfigurable metasurface unit cell array 262, the metasurface controller 264 may control the operation of a signal matching circuit, one or more attenuator circuits 297, or one or more tunable delay circuits 298 in various embodiments. For ease of understanding, the operation of the metasurface controller 264, attenuator circuit 297, and tunable delay circuit 298 will be described as controlling a single metasurface unit cell subgroup 290-1, 290-2 within the reconfigurable metasurface unit cell array 262. It is appreciated, however, that the metasurface controller 264 may control the operation of a single attenuator circuit 297 and tunable delay circuit 298 for a metasurface unit cell subgroup 290-1, 290-2 among a plurality of subgroups of metasurface unit cells 288-1, 288-2, 288-3, 288-4 within the reconfigurable metasurface unit cell array 262 in various embodiments.

As described in embodiments herein, each of the metasurface unit cells 288-1, 288-2, 288-3, 288-4 may include a actively reconfigurable or passive concentric circular resonating antennas that resonate with incident EM waves propagated omnidirectionally from one or more of the antennas 292-1, 292-2, 292-3 in the radiofrequency environment. The metasurface unit cells 288-1, 288-2, 288-3, 288-4 may include a conductive fixed tab within the concentric circular antennas or structures in an embodiment. Further, while concentric circular antennas are discussed in embodiments herein, any shape of concentric antennas for the reconfigurable active or the passive portions of resonating antennas or structures of the metasurface unit cell 288-1, 288-2, 288-3, 288-4 may be used.

In some embodiments, antennas 292-1, 292-2, 292-3 are formed on a periphery of reconfigurable metasurface unit cell array 262 or nearby the reconfigurable metasurface unit cell array 262. In other embodiments, the antennas 292-1, 292-2, 292-3 may resonate EM waves within the radiofrequency environment from other wireless information handling systems 200-1, 200-2, 200-3. The radiofrequency environment may include a standalone reconfigurable metasurface unit cell array 262 with plural wireless information handling systems 200-1, 200-2, 200-3 in some embodiments. In other embodiments, the metasurface unit cell array 262 may be formed onto or affixed to a chassis surface, such as a display chassis back surface 283, of one or more wireless information handling systems 200-1, 200-2, 200-3 in the radiofrequency environment.

The passive concentric circular resonating antennas of the metasurface unit cells 288-1, 288-2, 288-3, 288-4 in some embodiments may receive those incident EM waves and transfer the EM wave resonance through a coupler and to a microwave circuit placed below the passive concentric circular resonating antennas of each metasurface unit cell 288-1, 288-2, 288-3, 288-4. The microwave circuit of each metasurface unit cell 288-1, 288-2, 288-3, 288-4 act as the processing units that manipulate the captured EM wave energy from the passive concentric circular resonating antennas and couplers by receiving input signals from the passive concentric circular resonating antennas and couplers with adjusted signals being sent to synthesize a unified waveform of phase-shifted EM waves for propagation back to the metasurface unit cells 288-1, 288-2, 288-3, 288-4. In an embodiment, one or more impedance match junctions between each of the microwave circuits may be used to direct those signals from each microwave circuit to a signal matching circuit that optimizes signal flow into other processing elements described herein.

In an embodiment, the signal matching circuit ensures that optimal impedance alignment as energy flows from the microwave circuits. In an embodiment, the signal matching circuit refines impedance alignment thereby enhancing the signal quality from each of the microwave circuits of each of the metasurface unit cells 288-1, 288-2, 288-3, 288-4 to minimize potential power losses during transmission.

After the impedance of each signal from each of the microwave circuits has been matched, the signal may be compared at the attenuator circuit 297 and tunable delay circuit 296 to a bias reference input operatively coupled to the metasurface controller 264. In an embodiment, the bias reference input is received as input to the attenuator circuit 297 and tunable delay circuit 298 to control or change the phase-shift level or attenuation level of the captured, incident radiofrequency signal from the signal matching circuit at each metasurface unit cell 288-1, 288-2, 288-3, 288-4 or across plural metasurface unit cells 288-1, 288-2, 288-3, 288-4 in a subgroup 290-1 or 290-2. In an embodiment, the bias reference input is an actuation voltage for adjustment to tunable components such as the attenuator circuit 297 and tunable delay circuit 298 for selection of attenuation applied or selection of a plurality of phase-shift levels applied to the incoming captured, radiofrequency signal from the signal matching circuit with the amplitude and phase characteristics of the phase-shift applied via a amplitude and delay applied as defined by the bias reference input. The tunable delay circuit 298 may apply a phase shift delay to the signal so as to align or oppose the phase of the wavefronts of the emitted and reflected signals at the resonating antennas or structures thereby contributing to constructive or destructive interference patterns created at the reconfigurable metasurface unit cell array 262 across plural metasurface unit cells 288-1, 288-2, 288-3, 288-4. In an embodiment, the attenuator circuit 297 also adjusts the amplitude of the incoming signal from the signal matching circuit from the bias reference input to determine amplitude of a generated radiofrequency signal to determine levels of constructive or destructive interference applied to an incident incoming EM wave. The bias reference input is a voltage level that may switch switchable elements to dictate the attenuation level needed for amplitude that may achieve the desired signal strength gain or reduction, such as for generating a null region depending on the phase-shift applied by the tunable delay circuit 298.

As described herein, the metasurface controller 264 may receive initial data that describes, for each wireless transmission, RSSI data, SINR data, and AoA data. For example, a first set of RSSI data, SINR data, and AoA data may be received that is associated with a first wireless transmission to or from the first information handling system 200-1. Similarly, a second set of RSSI data, SINR data, and AoA data may be received that is associated with a second wireless transmission to or from the second information handling system 200-2. Additionally, a third set of RSSI data, SINR data, and AoA data may be received that is associated with a third wireless transmission to or from the third information handling system 300-3. It is appreciated that for every wireless transmission to or from any network device may also have associated RSSI data, SINR data, and AoA data with it and the metasurface controller 264 may receive this data.

With this data, the metasurface controller 264 may process the data and other wireless network data with execution of machine readable code instruction of a wireless network feature extraction module 270. In an embodiment, the machine readable code instructions of the wireless network feature extraction module 270 may be executed by the metasurface NPU 299, which may be part of or in addition to metasurface controller 264, to extract certain features identified within the sets of RSSI data, SINR data, and AoA data for the radiofrequency signals. This may include, for example, location of each of the information handling systems 200-1, 200-2, 200-3, movement of each of the information handling systems 200-1, 200-2, 200-3, introduction of each new information handling system 200-1, 200-2, 200-3 within the wireless network, and prioritization wireless network data of each of the each of the information handling systems 200-1, 200-2, 200-3, availability in the physical environment of the radiofrequency environment for additional access points, among other features. For example, where the reconfigurable metasurface unit cell array 262 forms part of a wireless network within a hospital, the metasurface controller 264 may receive not only the RSSI data, SINR data, and AoA data associated with the wireless transmissions from and to each of the information handling systems 200-1, 200-2, 200-3, but may receive data indicating preferential treatment of wireless transmissions of some radiofrequency signals to and from an information handling system 200-1. For example, information handling system 200-1 may be operated by a doctor or nurse as opposed to those wireless transmissions from network devices, such as 200-2 or 200-3, not recognized as having such preferential treatment (e.g., an information handling system operated by a patient or visitor to the hospital). Depending on wireless network congestion or other factors such as RSSI, SINR and the like determined from the wireless network feature extraction module 270, the metasurface controller 264 and NPU 299 may operate to control radiofrequency signals via antennas 292-1, 292-2, 292-3 or reconfigurable metasurface unit cell arrays 262 within the radiofrequency environment. As network devices enter and leave the wireless network (e.g., joins the wireless network via an authentication process), this data may also be included to that data provided to the wireless network feature extraction module 270.

Once the features have been extracted, the data and features may be provided to a metasurface NPU 299. In an embodiment where one or more ML algorithms need to be trained, this data and features may, instead, be provided to a machine learning training module 272 to train any of the first ML algorithm 293-1, second ML algorithm 293-2, and/or third ML algorithm 293-3. Additionally, where new or additional ML algorithms are uploaded to the metasurface memory device 294, the machine learning training module 272 may train these new or additional ML algorithms using the RSSI data, SINR data, AoA data and other wireless features obtained from the wireless network feature extraction module 270. The training of the ML algorithms 293-1, 293-2, 293-3 and the results of that training may be provided to a feedback module 274 that passes this information onto the metasurface controller 264 indicating the status of the training of each ML algorithm 293-1, 293-2, 293-3.

Where, however, the ML algorithms 293-1, 293-2, 293-3 do not need to be trained, the metasurface NPU 299 may execute the machine readable code instructions of the one or more ML algorithms 293-1, 293-2, 293-3 depending on the currently-detected wireless network conditions of the radiofrequency environment as described herein. It is appreciated that these plurality of types of ML algorithms 293-1, 293-2, 293-3 may each be optimally suited serve a specific purpose for wireless signal operations and executing software applications among the plural information handling systems 200-1, 200-2, 200-3. For example, some ML algorithms 293-1, 293-2, 293-3 may be better suited for diverse data types and features such as a CNN algorithm that is best suited for visual data while a LSTM network algorithm may be best suited for sequential data. For specialized task requirements at the reconfigurable metasurface unit cell array 262, a ML algorithm 293-1, 293-2, 293-3 focused on anomaly detection and a ML algorithm focused on resource allocation and real-time decision-making requirements may be used. Still further, in some example embodiments where physical environmental variability is a concern or is detected within the wireless network, a single ML algorithms 293-1, 293-2, 293-3 may not be flexible enough to adapt to changes within the wireless network and, therefore, an ensemble ML algorithms 293-1, 293-2, 293-3 may be used with the metasurface controller 264 executing machine readable code instructions of a plurality of ML algorithms 293-1, 293-2, 293-3 described above based on those changes in the wireless network.

Additionally, some wireless network environments may benefit from modularity, where different ML algorithms 293-1, 293-2, 293-3 being used to handle adjustment of different aspects of the reconfigurable metasurface unit cell array 262 or wireless antennas 292-1, 292-2, 292-3 during ongoing wireless operation of information handling systems 200-1, 200-1, 200-3 in the radiofrequency environment. This modular approach allows for easier updates and scalability, as new ML algorithms 293-1, 293-2, 293-3 are added or replaced. Having multiple ML algorithms 293-1, 293-2, 293-3 uploaded to a metasurface memory device 294 and executable by the metasurface controller 264 can provide redundancy thereby improving the reliability of the metasurface controller 264 to detect changes and adaptively enhance communications with the wireless network. If one ML algorithm 293-1, 293-2, 293-3 fails to accommodate for any detected anomalies within the wireless network or performs poorly in enhancing communication with the wireless network, other ML algorithms 293-1, 293-2, 293-3 may be executed that can help compensate for a first execute an ML algorithm 293-1 that does not sufficiently address wireless network issues thereby ensuring continuous and accurate operation of the reconfigurable metasurface unit cell array 262 within the radiofrequency environment. The ML algorithms 293-1, 293-2, 293-3 may optimize different aspects of the reconfigurable metasurface unit cell array 262 or antennas 292-1, 292-2, 292-3, such as power consumption, signal quality, and data throughput by using the trained ML algorithms 293-1, 293-2, 293-3 that may allow for more targeted optimization of the reconfigurable metasurface unit cell array 262 or antennas 292-1, 292-2, 292-3 that leads to overall system efficiency for radiofrequency signal communications for various purposes of information handling system 200-1, 200-2, 200-3 in the radiofrequency environment.

It is appreciated that the metasurface NPU 299 may, in an embodiment, select among the plurality of trained ML algorithms 293-1, 293-2, 293-3 depending on a detected AoA data of wireless transmissions at the reconfigurable metasurface unit cell array 262. Current angle-of-departure (AoD) data that has been extrapolated from the AoA data may also inform the metasurface NPU 299 of directionality and location of various different wireless network devices such as each of the information handling systems 200-1, 200-2, 200-3, other reconfigurable metasurface unit cell arrays, APs 244, and base stations 246 within the wireless network. In an example embodiment, each of the metasurface unit cells 288-1, 288-2, 288-3, 288-4 have a known spacing between them and are resonated by an incoming EM transmission causing a differential delay that may be detected between, for example, the first metasurface unit cell 288-1 and the second metasurface unit cell 288-2. This differential delay may be calculated and the AoA may be detected. This process may be completed between every metasurface unit cell 288-1, 288-2, 288-3, 288-4 having known spacing within each metasurface unit cell subgroup 290-1, 290-2 of the reconfigurable metasurface unit cell array 262 such that an AoA associated with each wireless transmission of radiofrequency signals in the radiofrequency environment may be determined by the metasurface controller 264.

It is also further appreciated that the metasurface NPU 299 may select among the plurality of ML algorithms 293-1, 293-2, 293-3 based on other factors. Other factors may include detected network congestion, data indicating tasks being performed by wireless devices within the radiofrequency environment, data indicating user prioritizations and congestion levels in wireless networks, data indicating physical environment challenges or limitations of a radiofrequency environment, among other factors used by the metasurface NPU 299 for selection of one or more ML algorithms among plural available ML algorithms optimally suited for such tasks in embodiments herein. In one example, the metasurface NPU 299 may select among the plurality of ML algorithms based on the current processing resources available and the anticipated compute resources consumed by executing the machine readable code instructions of a given ML algorithm 293-1, 293-2, 293-3. In another example, the metasurface NPU 299 may select an ML algorithm 293-1, 293-2, 293-3 based on the level of training of each of the ML algorithms 293-1, 293-2, 293-3 such that the best trained ML algorithms 293-1, 293-2, 293-3 are selected over yet-untrained or insufficiently trained ML algorithms 293-1, 293-2, 293-3. In an embodiment, the metasurface NPU 299 may request for new ML algorithms 293-1, 293-2, 293-3 be transmitted to the reconfigurable metasurface unit cell array 262 when the metasurface NPU 299 determines that the ML algorithms stored on the metasurface memory device 294 are not sufficient.

Where, for example, the metasurface controller 264 determines that the differential delay is consistent, the metasurface controller 264 may select a reinforcement learning ML algorithm as a base ML algorithm to maintain optimal radiofrequency signal reflection with fewer changes, including dramatic changes, in the radiofrequency environment than would come from, for example, wireless information handling systems 200-1, 200-1, 200-3 or access points that would be constantly moving such as on drones or robotic systems. This selection of the reinforcement learning ML algorithm may better optimize network traffic congestion within the wireless networks of the radiofrequency environment where the reconfigurable metasurface unit cell array 262 has been placed than would other types of ML algorithms 293-1, 293-2, 293-3. In an example embodiment where the wireless network environment is dynamic with the AoA, RSSI, SINR, (received from the SINR sensor 268 and RSSI sensor 266) and other dynamic network data changes are detected, the metasurface controller 264 may select a different type of ML algorithm such as a supervised ML algorithm that can be trained to accommodate for these dynamic changes in the wireless network environment. It is also appreciated that the metasurface controller 264 may dynamically switch between directing the metasurface NPU 299 to execute the machine readable code instructions of a first ML algorithm 293-1 to executing the machine readable code instructions of a second ML algorithm 293-2 based on the changing data received at the metasurface controller 264. It is also appreciated that the metasurface controller 264 may direct the metasurface NPU 299 to execute the machine readable code instructions of a plurality of ML algorithms 293-1, 293-2, 293-3 that have been amalgamated to customize the operating characteristics of the reconfigurable metasurface unit cell array 262 for changing conditions of individual radiofrequency signals of a wireless network or for radiofrequency signals from plural wireless networks in a radiofrequency environment.

The selection of one or more ML algorithms 293-1, 293-2, 293-3 may result in adjustments of the operation of the reconfigurable metasurface unit cell array 262 or antennas 292-1, 292-2, 292-3 within a radiofrequency environment. The metasurface controller 264 and NPU 299 executes machine readable code instructions of an RF performance and power consumption decision module 284 with the selected one or more ML algorithms 293-1, 293-2, 293-3 to output adjustments for one or more antennas 292-1, 292-2, 292-3 and for the reconfigurable metasurface unit cell array 262. For example, the metasurface controller 264, based on the output from the various ML algorithms 293-1, 293-2, 293-3 of the RF performance and power consumption decision module 284 executed by the metasurface NPU 299, may engage in directing that power provided to one or more on-board antennas 292-1, 292-2, 292-3 or, via wireless communication, that other wireless network antennas should receive more power or have power reduced. In other embodiments, power to addressable elements such as refractory heaters or bias signals to the microwave elements, such as an attenuator and phase delay circuit, of the reconfigurable metasurface unit cell array 262 may be adjusted in order to amplify or reduce those EM waves received incident to the reconfigurable metasurface unit cell array 262 based on the selected ML model algorithm selected for operation with the RF performance and power consumption decision module 284. For example, this allows the reconfigurable metasurface unit cell array 262 to amplify reflected EM waves and beamform those EM waves to a location in the radiofrequency environment. Again, this beamforming location may be based on an extrapolated AoD of a wireless communication signal to a specific network device (e.g., any of the information handling systems 200-1, 200-2, 200-3) detected by the metasurface controller 264.

Thus, where power adjustments to the on-board antennas 292-1, 292-2, 292-3 and/or adjustments to the microwave circuits of the reconfigurable metasurface unit cell array 262 are necessary, the metasurface controller 264 may execute machine readable code instructions of an RF performance and power consumption decision module 284 using a selected ML model algorithm. The selected ML model algorithm is selected from among the plurality of available ML model algorithms 293-1, 293-2, 293-3 for use with executing machine readable code instructions of the RF performance and power consumption decision module 284 that is optimal for the radiofrequency conditions, network traffic, tasks and prioritizations of wireless devices, and physical challenges or operation of wireless devices within the radiofrequency environment in embodiments of the present disclosure. The metasurface controller 264 executes machine readable code instructions of an RF performance and power consumption decision module 284 to determine to what degree the power provided should be altered or bias signals sent to microwave circuit elements should be used to adjust phase shifting for directionality and gain of reflected EM waves by a reconfigurable metasurface unit cell array 262 according to embodiments herein.

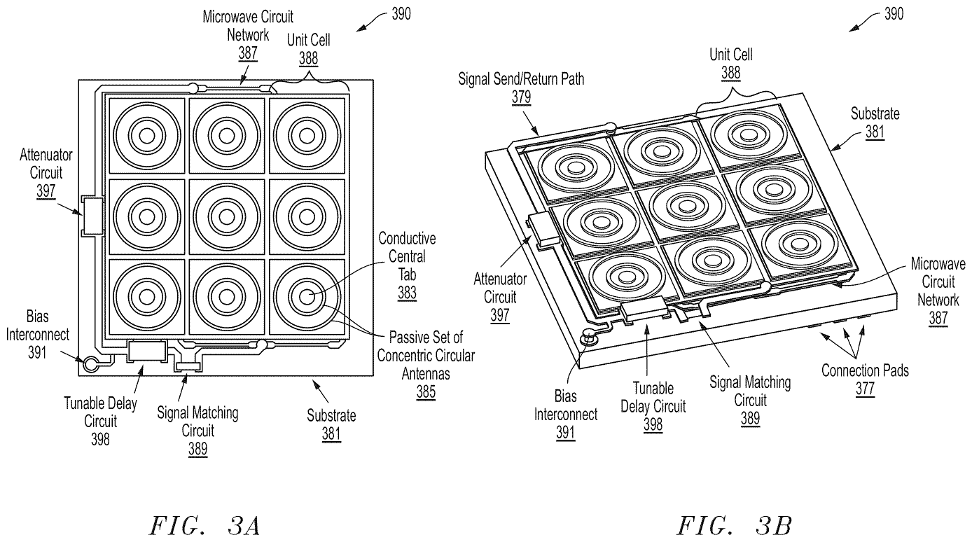

FIG. 3A is a top view graphic diagram showing one of a plurality of metasurface unit cell subgroups 390 of metasurface unit cells 388 of a reconfigurable metasurface unit cell array according to an embodiment of the present disclosure. Similarly, FIG. 3B is a perspective view graphic diagram one of a plurality of metasurface unit cell subgroups 390 of metasurface unit cells 388 of a reconfigurable metasurface unit cell array according to another embodiment of the present disclosure. Again, the metasurface unit cell subgroup 390 shown in FIGS. 3A and 3B may be an entire reconfigurable metasurface unit cell array or may form a subgrouping of unit cells 388 that may cooperate with similar subgroups of unit cells 388 to form a larger metasurface unit cell array. In the embodiments of FIGS. 3A and 3B, the unit cell structure shown includes concentric passive resonant antennas or structures. However, it is understood that any types of active or passive resonating antennas or structures may be used as reconfigurable metasurface unit cells with embodiments of the present disclosure. The unit cell structures of FIGS. 3A and 3B are an example embodiment.

FIGS. 3A and 3B show a unit cell structure for a plurality of reconfigurable metasurface unit cells 388. The reconfigurable metasurface unit cells 388 include a passive set of concentric circular antennas 385 that capture incident EM waves and resonate or reflect phase-shifted radiofrequency signals at a plurality of frequencies. The metasurface unit cells 388 may include a conductive fixed tab 383 within the concentric circular antennas 385 in an embodiment. Further, while concentric circular antennas 385 are discussed in embodiments herein, any shape of concentric antennas for the passive portions of the metasurface unit cell 388 may be used. In embodiments herein, the passive sets of concentric circular antennas 385 and the fixed tab 383 are formed of conductive material, such as metal, formed on a dielectric substrate 381, to form the reconfigurable metasurface unit cells 388. The passive sets of concentric circular antennas 385 of the reconfigurable metasurface unit cells 388 may receive those incident EM waves from antennas at the information handling system or from the radiofrequency environment and transfer the EM wave resonance through a coupler (not shown) and to a microwave circuit of a microwave circuit network 387 with each of the plurality of microwave circuits placed below each of the passive set of concentric circular antennas 385 of each reconfigurable metasurface unit cell 388. The microwave circuit of each reconfigurable metasurface unit cell 388 act as the processing circuit to capture the incident radiofrequency signal for manipulation of the EM wave energy captured from the passive set of concentric circular antennas 385 and couplers. By receiving captured radiofrequency signals incident on the passive set of concentric circular antennas 385 and couplers, these received radiofrequency signals are fed to tunable delay circuit 398 and the attenuator circuit 397 via a signal impedance matching circuit (not shown) and used to synthesize a phase-shifted reflected radiofrequency signal for transmission from across a plurality of reconfigurable metasurface unit cells 388 to form a unified waveform for reflection or retransmission of the reflected EM waves of an incident radiofrequency signal by the metasurface unit cell subgroup 390.

In an embodiment, one or more impedance match junctions formed between each of the microwave circuits may be used to direct those signals from each microwave circuits to a signal matching circuit 389, via a signal send/return path 379, that optimize signal flow into other processing elements such as the attenuator circuit 397 and the tunable delay circuit 398 described herein. In an embodiment, the signal matching circuit 389 ensures that optimal impedance alignment as energy flows from the microwave circuits to avoid power loss of the captured radiofrequency signal from the EM waves incident on the metasurface unit cells 388. In an embodiment, the signal matching circuit 389 refines impedance alignment thereby enhancing the signal quality from each of the microwave circuits of each of the metasurface unit cells 388 thereby minimizing potential power losses during capture and transmission for manipulation to generate a phase-shifted, reflected resonant radiofrequency signal by the metasurface unit cell subgroup 390.

After the impedance of each signal from each of the microwave circuits has been matched using the signal matching circuit 389, the captured incident radiofrequency signal may be sent to the attenuator circuit 397 and tunable delay circuit 398. The metasurface controller may provide a bias reference input voltage pursuant to execution of machine readable code instructions of a selected ML algorithm with the RF performance and power consumption decision module of embodiments herein via a bias interconnect 391 for control of the attenuator circuit 397 and tunable delay circuit 398. The bias interconnect 391 is, therefore, operatively coupled to the metasurface controller of the metasurface unit cell array. In an embodiment, the bias reference input from the bias interconnect 391 is received as input to the attenuator circuit 397 and tunable delay circuit 398 to adjust amplitude attenuation level and phase-shift level applied to the captured radiofrequency signal fed from the signal matching circuit 389.

In an embodiment, the bias reference input is an actuation voltage for adjustment to tunable components such as the attenuator circuit 397 and tunable delay circuit 398 for selection of a plurality of phase-shift levels applied to or attenuation applied to the incoming captured, radiofrequency signal from the signal matching circuit. The adjusted phase characteristics and gain or reduction in amplitude may be defined by the bias reference input level selection sent from the metasurface hardware controller to those tunable components in the reconfigurable metasurface unit cell subgroup. The tunable delay circuit 398 may apply a delay in the radiofrequency signal, such as via tunable resistive and capacitive components, to phase shift the captured, incident radiofrequency signal at any selectable phase shift step, such as anywhere from zero degrees to 180 degrees phase shift. This is done to align or oppose the phase of the wavefronts of the captured radiofrequency signal with the incident EM waves of the incoming radiofrequency signal at the surface of the reconfigurable metasurface unit cells 388. This phase-shifted, captured radiofrequency signal may be then blended into a reflected EM signal at the reconfigurable metasurface unit cell array with the phase-shifted, captured incident radiofrequency signal thereby contributing to constructive or destructive interference patterns across the plurality of metasurface unit cell 388 to form directionality lobes and either gain or attenuation of amplitude in the reflected radiofrequency signals. In another embodiment, the attenuator circuit 397 also adjusts the amplitude of the incoming captured, incident radiofrequency signal from the signal matching circuit 389 via selection of a voltage divider circuit actuated by the bias reference provided at the bias interconnect 391 which may affect the amount of gain or reduction of the combined, reflected radiofrequency signal. Matching amplitudes may double or virtually cancel the combined, reflected radiofrequency signal, for example, while a lower amplitude in the captured radiofrequency signal may generate less gain or less cancellation depending on the phase shift. The bias reference input is an actuation voltage to actuate tunable components, such as the attenuator circuit 397 and the tunable delay circuit 398 to dictate the attenuation level and phase shift level needed to achieve the desired signal strength and directionality lobe of the reflected EM wave or to step back destructive interference of generated null regions or regions of reduced radiofrequency signal when additional radiofrequency signal bandwidth is needed.

In order to beamform the reflected EM waves of the one or more wireless transmissions within the wireless network, constructive or destructive interference in the combined, reflective radiofrequency signal may be employed across plural metasurface unit cells 388, any subset number of metasurface unit cells 388, or the metasurface unit cell subgroup 390 in embodiments herein. In an example embodiment, when the EM waves from the antennas at the network devices interact with the signals processed for phase shifting or alignment and reflected by the metasurface unit cell subgroup 390, the phase alignment from the operation of the tunable delay circuit 398 may be tuned such that troughs of one signal align with either troughs or peaks of another at between 0 degrees (in phase) to a 180 degrees (out of phase) for any phase shift to either increase or cancel/reduce the EM wave energy in particular reflective directions and creating the directionality lobes of the reflected EM wave or the radiofrequency signal at various level. This may impart gain or even reduction of signal amplitudes dependent on direction thereby further enhancing directionality lobes. Amplitude control by the attenuator circuit 397 may further ensure that the combined captured radiofrequency signals and incident radiofrequency signals have equal magnitudes thereby enhancing a gain effect of constructive interference or cancellation effect used in destructive interference. In other embodiments, the amplitude magnitude of the captured radiofrequency signal that is phase-shifted may be something less than the magnitude of the incident radiofrequency signal providing further control over gain or reduction.

It is appreciated that constructive interference techniques may be employed such that, for example, the phase and amplitude adjustments by the tunable delay circuit 398 and attenuator circuit 397, respectively, align the captured, phase-delayed radiofrequency signal with the incident radiofrequency signal in the reflected radiofrequency signal from the metasurface unit cell subgroup 390 strengthening the emitted EM signals for the reflected radiofrequency signal and extending the EM radiofrequency signal lobes in some embodiments. Other portions of the radiofrequency signal, such as reflections of radiofrequency signals in other directions than the intended directionality lobe or other frequencies such as for noise or harmonics may be subject out of phase radiofrequency signals to reduce or cancel the emitted EM signals for the reflected radiofrequency signal in other directions or for other frequencies. These EM radiofrequency signal directionality lobes may be beamformed by some portion of metasurface unit cells 388 of the metasurface unit cell subgroup 390 towards a receiving device such as an AP, base station, or information handling system for better transmission or reception in the radiofrequency environment.

In an embodiment, the metasurface unit cell subgroup 390 may include one or more connection pads 377 under the substrate 381 of the metasurface unit cells 388 that allow the metasurface controller to be operatively coupled to the attenuator circuit 397, tunable delay circuit 398, and other elements on the metasurface unit cell subgroup 390 or metasurface unit cell array for provision of a bias voltage to the bias interconnect 391 disposed through the dielectric substrate 381. It is appreciated that various connection pads 377 may be formed below a substrate 381 layer of the metasurface unit cell subgroup 390 with leads passing through the dielectric substrate 381 and to the various elements such as the tunable delay circuit 398 and attenuator circuit 397.

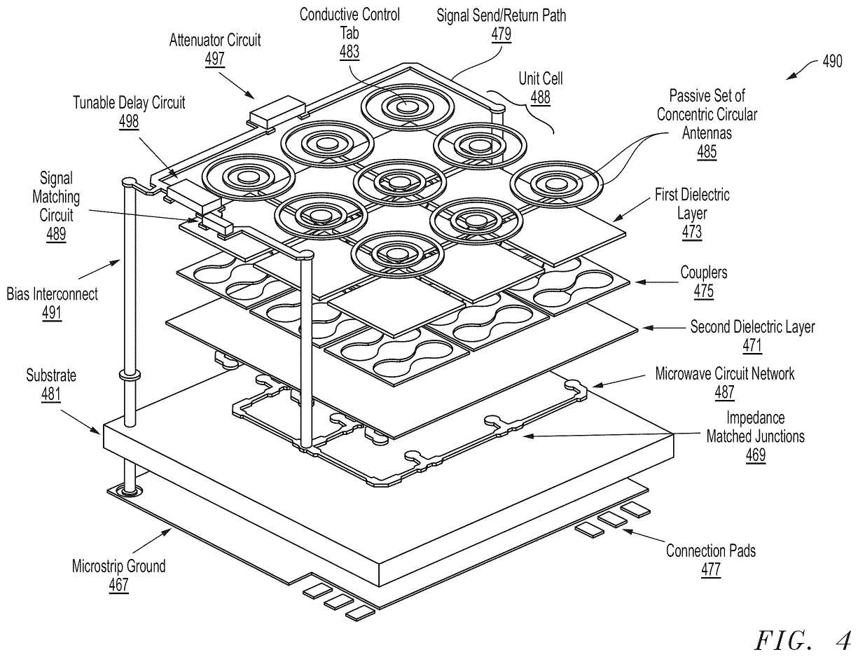

FIG. 4 is an exploded perspective view graphic diagram showing one of a plurality of metasurface unit cell subgroups 490 of metasurface unit cells 488 of a reconfigurable metasurface unit cell array according to another embodiment of the present disclosure. This exploded view may show additional elements within each of the unit cells 488 while also showing similar elements to those described in connection with FIGS. 3A and 3B, for example. It is appreciated that each of the metasurface unit cells 488 may be controlled via operation of the metasurface controller described in connection with, for example FIGS. 1 and 2, pursuant to output from execution of machine readable code instructions for a selected one or more ML algorithms with an RF performance and power consumption decision module executed by a metasurface NPU and the metasurface hardware controller as described in embodiments herein. In an embodiment, this control may include the provisioning of power or bias voltage control to one or more of the microwave circuits of the microwave circuit network 487 in order to beamform reflected EM waves off of the surface of the metasurface unit cell array.

FIG. 4 shows the passive set of concentric circular antennas 485 that are conductive resonant structures sized and spaced to capture incident EM waves of radiofrequency signals in a radiofrequency environment. This passive set of concentric circular antennas 485 is sized and spaced with conductive resonant structure elements to reflect and resonate at a plurality of frequencies that may be phase-shifted or aligned with the captured radiofrequency signals within a radiofrequency environment. The metasurface unit cells 388 may include a conductive fixed tab 483 within the concentric circular antennas 485 in an embodiment. Further, while concentric circular antennas 485 are discussed in embodiments herein, any shape of concentric antennas for the passive portions of the metasurface unit cell 488 may be used. Again, the passive sets of concentric circular antennas 485 of the metasurface unit cells 488 may receive those incident EM waves and transfer the EM wave radiofrequency signal through a couplers 475 in a conductive coupling layer with apertures formed therein under the passive set of concentric circular antennas 485. The couplers 475 capture and transfer the EM wave radiofrequency signal, captured from the passive set of concentric circular antennas 485 and as separated by first dielectric layer 473, to a microwave circuit forming part of the microwave circuit network 487 under the reconfigurable metasurface unit cell subgroup 490. Each of the metasurface unit cells 488 has one of the plurality of microwave circuits placed below each of the passive set of concentric circular antennas 485 to provide the captured EM wave radiofrequency signal coupled thereto to the microwave circuit network 487. The microwave circuit network 487 of the plural metasurface unit cells 488 acts as the processing units that manipulate the captured EM wave energy of the captured incident radiofrequency signal at the passive set of concentric circular antennas 485 and couplers 475 by receiving those captured radiofrequency signals from the passive set of concentric circular antennas 485 and couplers 475. The microwave circuit network 487 operatively couples a synthesized a unified waveform captured from the metasurface unit cells 488 to a signal matching circuit 489, tunable delay circuit 498 and an attenuator circuit 497 to apply phase-shifting and amplitude adjustment to those captured radiofrequency signals for further manipulation for phase shifting or alignment in a reflected radiofrequency signal at the passive set of concentric circular antennas 485 of the metasurface unit cells 488.

In an embodiment, one or more impedance matched junction 469 formed between each of the microwave circuits of the microwave circuit network 487 may be used to direct those captured radiofrequency signals from each of the microwave circuits to a signal matching circuit 489, via a signal send/return path 479, that optimizes signal flow into other processing elements described herein and minimizes distortion or power loss of the captured radiofrequency signal. In an embodiment, the signal matching circuit 489 ensures that optimal impedance alignment as energy flows from the microwave circuits. In an embodiment, the signal matching circuit 489 refines impedance alignment thereby enhancing the signal quality from each of the microwave circuits of each of the unit cells 488 thereby minimizing potential power losses and distortion during transmission of those captured radiofrequency signals for manipulation and reflection back via the metasurface unit cell array.

After the impedance of each signal from each of the microwave circuits of the microwave circuit network 487 has been matched using the signal matching circuit 489, the captured, incident radiofrequency signal may be adjusted at the attenuator circuit 497 and tunable delay circuit 498 based on a bias reference input provided at a bias interconnect 491 operatively coupled from the metasurface controller of the metasurface unit cell array. In an embodiment, the bias reference input from the bias interconnect 491 is received as input actuation voltage to the tunable delay circuit 498 to select a phase-shift level to be applied to the EM waves of the captured, incident radiofrequency signal from the signal matching circuit 489. In another embodiment, the bias reference input from the bias interconnect 491 is received as input actuation voltage to the attenuator circuit 497, which may be tunable in some embodiments, to select an amplitude level to be applied to the EM waves of the captured, incident radiofrequency signal from the signal matching circuit 489. The tunable delay circuit 498 may apply a phase shift to the captured, incident radiofrequency signal EM waves so as to align or oppose the phase of the wavefronts at various phase-shift levels for combination with the EM wavefronts of incident radiofrequency signal received at the one or more metasurface unit cells 488 in embodiments herein. As a result, the phase-shift levels of the phase-shifted, captured incident radiofrequency signal contribute to constructive or destructive interference patterns created in reflected radiofrequency signals at the metasurface unit cell subgroup 490 of the metasurface unit cell array for beamforming directionality lobes and amplitude gain or reduction. In an embodiment, the attenuator circuit 497 also adjusts the amplitude of the incoming captured, incident radiofrequency signal with voltage divider circuits selected at the tunable attenuator circuit 497 based on the bias reference input provided at the bias interconnect 491. The bias reference input is an actuation voltage to dictate phase-shift level or the attenuation level needed from the tunable delay circuit 498 or a tunable attenuator circuit 497, if used, to achieve the desired signal strength to increase EM wave radiofrequency signals at directional EMF radiofrequency signal lobes when radiofrequency bandwidth is needed according to requirements determined from execution of the RF performance and power consumption decision module at the metasurface hardware controller and metasurface NPU.

In an embodiment, the metasurface unit cell subgroup 490 of the reconfigurable metasurface unit cell array may include one or more connection pads 477 that allow the metasurface controller to be operatively coupled to the attenuator circuit 497, tunable delay circuit 498, and other elements on the metasurface unit cell subgroup 490 of the metasurface unit cell array. It is appreciated that various connection pads 477 may be formed below a substrate 481 layer of the metasurface unit cell subgroup 490 with leads passing through the substrate 481 and to the various elements such as the tunable delay circuit 498 and attenuator circuit 497. Additionally, the metasurface unit cell subgroup 490 may include a microstrip ground 467 that may act as a grounding source for the various circuits in the metasurface unit cell subgroup 490 as well as a shielding from electrical interference. Still further, a first dielectric layer 473 and second dielectric layer 471 may also be placed within the stack of the metasurface unit cell subgroup 490 such that the couplers 475 are electrically insulated from both the passive set of concentric circular antennas 485 and microwave circuit network 487.

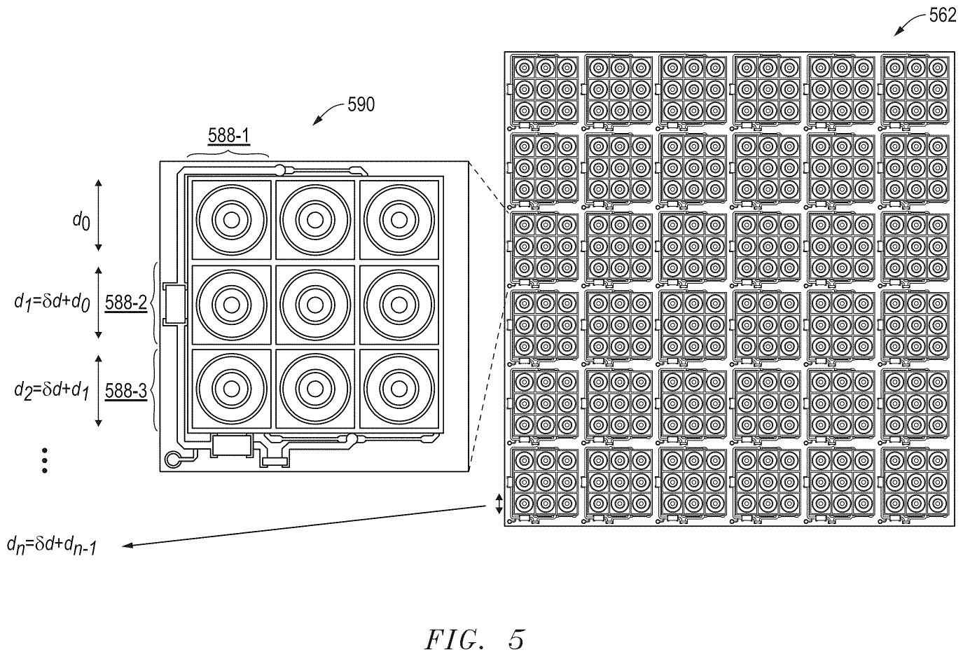

FIG. 5 is a top view graphic diagram showing one of a plurality of metasurface unit cell subgroups 590 forming a portion of a reconfigurable metasurface unit cell array 562 used to detect angle-of-arrival (AoA) of a wireless transmission within the wireless network and determine an appropriate angle-of-departure (AoD) for those wireless transmission radiofrequency signals reflected or retransmitted off of the reconfigurable metasurface unit cell array according to an embodiment of the present disclosure. As described herein, the metasurface unit cell subgroup 590 may be one of a plurality of metasurface unit cell subgroups 590 that form a complete reconfigurable metasurface unit cell array 562. In an embodiment, each of the metasurface unit cell subgroups 590 may include those elements and circuits described in connection with FIGS. 3A, 3B, and 4. Other types of metasurface unit cells are also contemplated for use with the reconfigurable metasurface unit cell array 562 according to various embodiments herein including those with reconfigurable or passive resonating antenna structures in various embodiments herein.

During operation, each of the metasurface unit cell subgroups 590 of the reconfigurable metasurface unit cell array 562 may interact with a plurality of wireless transmissions (e.g., EM waves) from a plurality of network devices located within and operatively coupled to a wireless network or wireless networks in a radiofrequency environment. These wireless transmissions may include high frequency transmissions that may be boosted and beamformed by the operation of the reconfigurable metasurface unit cell array 562 such that they may be relayed to the appropriate receiving device within the radiofrequency environment. In an embodiment, some of these wireless transmissions may be boosted by operation of the reconfigurable metasurface unit cell array 562 such that the effective range of the transmission from the source wireless device is increased in the radiofrequency environment. Still further, in high network traffic environments such as a hospital or a mall, the prioritization of these transmissions and directionality of the reflection of these wireless radiofrequency transmissions for particular prioritized users at the reconfigurable metasurface unit cell array 562 may be controlled by the metasurface controller and/or metasurface NPU executing computer-readable program code of a first set of selected one or more ML model algorithms that help to enhance these communications within a wireless network in the radiofrequency environment. Further, the detected physical environment, which may have physical challenges received as factors, such as inability to locate access points or unreliability of reach to wireless devices such as IoT wireless devices, in a radiofrequency environment, such that the operation of the reconfigurable metasurface unit cell array 562 may be controlled by the metasurface controller and/or metasurface NPU executing computer-readable program code of a different set of selected one or more ML model algorithms that help to enhance these wireless communications within the radiofrequency environment. In other embodiments, dynamically changing detected wireless conditions, such as fluid RSSI or SINR values for radiofrequency transmissions such as due to mobility of wireless devices, may cause the reconfigurable metasurface unit cell array 562 to be controlled by the metasurface controller and/or metasurface NPU executing computer-readable program code of yet a different set of one or more ML model algorithms that help to enhance these communications within the radiofrequency environment.

In order to determine the AoA and, accordingly, the AoD of each wireless transmission received at the reconfigurable metasurface unit cell array 562, the metasurface controller may be provided with appropriate differential delay data from each of the plurality of unit cells 588 having known spacing and distance lengths yielding differential times d₀, d₁, d₂ and so forth to dₙ that an EM wave of an incident radiofrequency signal is received within each of the metasurface unit cell subgroups 590 of the reconfigurable metasurface unit cell array 562.

For example, because the RF transmission signals in incident radiofrequency signals from a source wireless device antenna in a radiofrequency environment may interact with a first unit cell 588-1 at a different in time of arrival than may be detected at a second unit cell 588-2, and a third unit cell 588-3 all with known spacing from one another. The time of arrival of the RF transmission at the first cell 588-1 may be set at a first differential time “d₀” in an embodiment. Thus, the first differential delay “d₁” t the second unit cell 588-2 may be computed by adding the first differential time first differential time “d₀” to a detect time difference “δd” between the arrival of the RF transmission at the first cell 588-1 and the arrival of the RF transmission of the second unit cell 588-2 based on the known spacing distance as well as the frequency or wavelength of the incident radiofrequency signal. This may be repeated for each unit cell 588-1, 588-2, 588-3 such that a differential delay at any given unit cell “dₙ” may be defined by the following equation: dₙ−δd +dₙ₋₁. This calculation, in an example embodiment, may be conducted by the metasurface controller to arrive at an AoA for each of the plurality of RF transmissions detected at the surface of the entire reconfigurable metasurface unit cell array 562. Additionally, the AoD of the RF transmission from the RF transmission-originating wireless network device, which may also be target wireless devices for return communications, may also be calculated by the metasurface controller to determine a physical direction and/or location of the RF transmission-originating wireless network devices and target wireless devices within the radiofrequency environment for a given wireless network operating therein. This AoA data and AoD data, along with the detected RSSI and SINR data, may be passed onto the wireless network feature extraction module described in connection with FIGS. 1 and 2 for further processing as described herein. This data, indeed, may be used to both train one or more ML algorithms by the machine learning training module. These one or more ML model algorithms may then be used with execution of machine readable code instructions of the RF performance and power consumption decision module and inference engine modules to provide output from the one or more ML algorithms for adjustment to the metasurface unit cell subgroups 590 forming a portion of a reconfigurable metasurface unit cell array 562 as well as any transmitting and receiving antennas to help to dynamically enhance wireless communication within the radiofrequency environment.

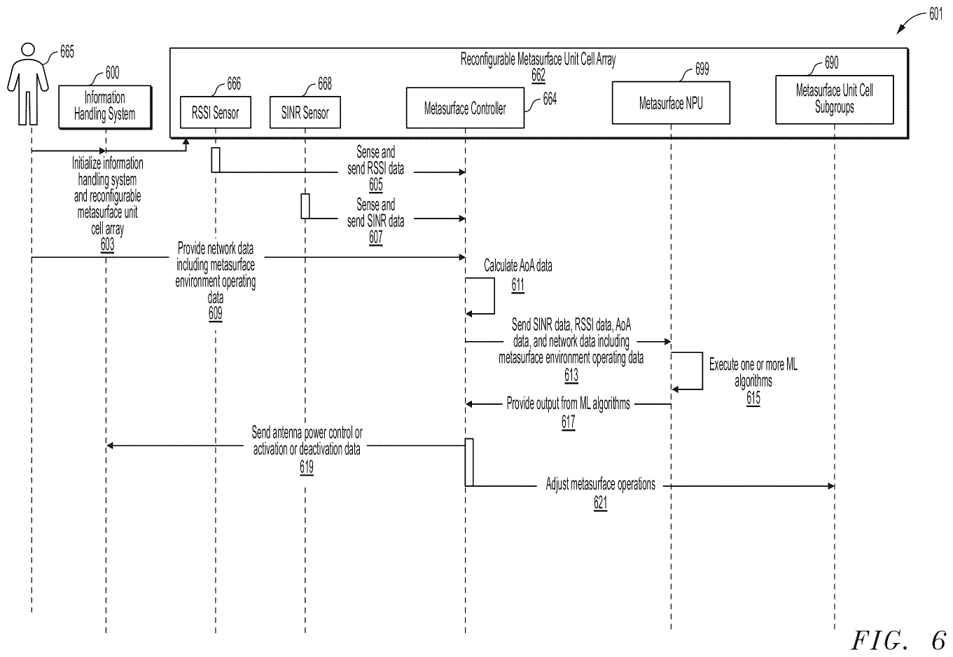

FIG. 6 is a swimlane diagram showing a method 601 of adaptively enhancing a communication system within one or more wireless networks of a radiofrequency environment at a reconfigurable metasurface unit cell array according to an embodiment of the present disclosure. It is appreciated that the reconfigurable metasurface unit cell array 662 may be similar to those metasurface unit cell arrays 662 described in connection with FIGS. 1, 2, and 5.

At line 603, the method 601 includes the user 665 initializing the information handling system 600 and the reconfigurable metasurface unit cell array 662. The user 665 may initialize the information handling system 600 by actuating a button at the information handling system 600 that initializes power to a hardware processor of the information handling system 600. The user 665 may initialize the reconfigurable metasurface unit cell array 662, which may be a standalone reconfigurable metasurface unit cell array 662 in some embodiments, by coupling the reconfigurable metasurface unit cell array 662 to a power source (e.g., metasurface PMU 178, FIG. 1) and actuating a button at the reconfigurable metasurface unit cell array 662. In an embodiment, the reconfigurable metasurface unit cell array 662 may be placed at a location within a wireless network where wireless transmissions may be reflected off of the surface of the reconfigurable metasurface unit cell array 662 so that the transmission of any given wireless transmission may be extended within radiofrequency environment for the wireless network or that wireless transmissions may be reflected around objects such as walls within the radiofrequency environment.

At line 605, the method 601 may include sensing, at an RSSI sensor 666, RSSI data and sending that data to a metasurface controller 664. Additionally, at line 607, an SINR sensor 668 senses SINR data and sends that SINR data to the metasurface controller 664. It is appreciated that the RSSI sensor 666 and SINR sensor 668 may detect and send the RSSI data and SINR data that is associated with each of the wireless radiofrequency transmissions (EM waves) incident to the reconfigurable metasurface unit cell array 662. In other embodiments, RSSI and SINR data may be received from source and target wireless devices within the radiofrequency environment for the radiofrequency signals communicated therebetween. Such remote RSSI and SINR data may be transmitted to the standalone reconfigurable metasurface unit cell array 662 via a metasurface wireless adapter from the networked wireless devices in the radiofrequency environment. In some embodiments, the reconfigurable metasurface unit cell array 662 may operate as part of or operatively coupled to a wireless device, such as wireless laptop information handling system, in the radiofrequency environment and may collect RSSI or SINR data. Because the RSSI sensor 666 and SINR sensor 668 are formed on the reconfigurable metasurface unit cell array 662 in an embodiment, the RSSI sensor 666 and SINR sensor 668 may detect the RSSI data and SINR data for each wireless transmission to the reconfigurable metasurface unit cell array 662 in real-time thereby updating the metasurface controller 664 with any changes to each set of RSSI data and SINR data. Alternatively, RSSI and SINR sensor data may be transmitted to the reconfigurable metasurface unit cell array 662 and metasurface controller 664 in real time or periodically from wireless networked devices in the radiofrequency environment.

At line 609, the method 601 also includes the user 665, via the information handling system 600, providing network data to the metasurface controller 664 that includes metasurface environment operating data as described herein. This metasurface environment operating data may include wireless network type data and wireless features data within the wireless network that have been identified by the user 665 as describing the environment that the reconfigurable metasurface unit cell array 662 has been placed within. For example, the metasurface environment operating data for the radiofrequency environment may include a list of preferred network devices within a wireless network in one embodiment. For example, where the reconfigurable metasurface unit cell array 662 has been placed within a hospital or a mall, a preferred network device may be a device operated by a doctor or a security guard. These preferred devices may be given higher priority for bandwidth and network resources compared to other network devices. In another example embodiment, the metasurface environment operating data for the radiofrequency environment may include data describing the locations of one or more network devices such as an access point or base station that generally remain in a specific location. In another example embodiment, the metasurface environment operating data for the radiofrequency environment may include data describing dynamically changing wireless condition such as mobile wireless devices operating in a radiofrequency environment, such as drones, robots, laptops, vehicular information handling systems, or mobile device information handling systems. In another example embodiment, the metasurface environment operating data for the radiofrequency environment may include data describing physical environmental challenges such as metallic buildings and machinery, caustic chemical or moist physical environment for difficult circumstances for placement of access points, or vibrational or caustic environments for wireless devices, such as IoT sensing systems, in the physical environment of the radiofrequency environment where the reconfigurable metasurface unit cell array 662 may operate. Additional metasurface environment operating data for the radiofrequency environment may include data describing may include peak hours where network traffic is higher than usual, off-peak hours where network traffic is lower than usual, and other data that the user 665 may provide that anticipates fluctuations in network traffic within the wireless network operating in a radiofrequency environment.

During operation of the reconfigurable metasurface unit cell array 662, any of a plurality of wireless transmissions may be transmitted such that they reach the reconfigurable metasurface unit cell array 662. In an embodiment, the microwave circuits of each metasurface unit cell in the metasurface unit cell subgroups of the reconfigurable metasurface unit cell array 662 may perform the task of determining this AoA data of any given wireless transmission in the radiofrequency environment. In an embodiment, the passive concentric circular resonating antennas of the metasurface unit cells may receive those incident EM waves and transfer the EM wave resonance of captured radiofrequency signals through a coupler and to the microwave circuit placed below the passive concentric circular resonating antennas of each metasurface unit cell as described in connection with, for example, FIGS. 3A, 3B, and 4. The microwave circuit of each metasurface unit cell act as the processing units that can detect this AoA of the incident EM waves and send that data to the metasurface controller 678 for further processing as described herein. It is understood that the metasurface unit cells shown in the embodiments of FIGS. 3A, 3B, and 4 may be used, but it is contemplated that any other type of metasurface unit cells may be used, including with reconfigurable resonating structures or with passive resonating structures in other embodiments herein.

After the AoA data is calculated for each incoming EM wave, the method 601 includes sending the SINR data, the RSSI data, the AoA data, and other radiofrequency environment data including the metasurface environment operating data to the metasurface NPU 699 at line 613. As described herein, the NPU may execute machine readable code instructions of one or more ML algorithms using the SINR data, the RSSI data, the AoA data, and the network data including the metasurface environment operating data as input. It is appreciated that the metasurface NPU 699 may select among the plurality of ML algorithms based on a number of factors as determined from metasurface environment operating data and radiofrequency environment data. Example factors may include detected network congestion of one or more wireless networks, data indicating tasks being performed by wireless devices within the radiofrequency environment, data indicating user prioritizations and congestion levels in wireless networks, data indicating physical environment challenges or limitations of a radiofrequency environment, among other factors used by the metasurface NPU 699 for selection of one or more ML algorithms among plural available ML algorithms optimally suited for radiofrequency signal adjustments for such tasks in embodiments herein. In another example, the metasurface NPU 699 may select among the plurality of ML algorithms based on the current processing resources available and the anticipated compute resources consumed by executing the machine readable code instructions of a given ML algorithm. In yet another example, the metasurface NPU 699 may select a ML algorithm based on the level of training of each of the ML algorithms such that the best trained ML algorithms are selected over yet-untrained or insufficiently trained ML algorithms. In an embodiment, the metasurface NPU 699 may request that new ML algorithms be transmitted to the reconfigurable metasurface unit cell array 662 when the metasurface NPU 699 determines that the ML algorithms stored on the metasurface memory device are not sufficient.

Where, for example, the metasurface controller 664 determines that the differential delay is consistent, the metasurface controller 664 may select a reinforcement learning ML algorithm as a base ML algorithm for use with executing machine readable code instructions of an inference engine and with the RF performance and power consumption decision module in an embodiment. This selection of the reinforcement learning ML algorithm may be better optimized to determine adjustments to the reconfigurable metasurface unit cell array 662 and antenna systems in the radiofrequency environment to accommodate network traffic congestion within the wireless network or networks of the radiofrequency environment than would other types of ML algorithms available. In another example embodiment where the wireless network environment is dynamic with the AoA, RSSI, SINR, and other network data changes dynamically detected, the metasurface controller 664 may select a different type of ML algorithm such as a supervised ML algorithm that can be trained to accommodate for these dynamic changes in the wireless network environment for use with executing machine readable code instructions of an inference engine and with the RF performance and power consumption decision module. In yet other embodiments where the metasurface controller receives detected AoA, RSSI, SINR, and other wireless network data as well as various challenging physical environment factors or for particular tasks to be performed by wireless devices in the radiofrequency environment such as predictive maintenance of wireless devices or difficult to reach wireless devices, the metasurface controller 664 may select yet a different type of ML algorithm with executing machine readable code instructions of an inference engine and with the RF performance and power consumption decision module optimized to those tasks to be executed or operations within a challenging physical environment of the radiofrequency environment.

It is also appreciated that the metasurface controller 664 may dynamically switch between directing the metasurface NPU 699 to execute the machine readable code instructions of a first ML algorithm to executing the machine readable code instructions of a second ML algorithm with an inference engine and the RF performance and power consumption decision module based on the changing radiofrequency environment data or other network data received at the metasurface controller 664. It is also appreciated that the metasurface controller 664 may direct the metasurface NPU 699 to execute the machine readable code instructions of a plurality of ML algorithms with executing machine readable code instructions of an inference engine and the RF performance and power consumption decision module that have been amalgamated to customize the operating characteristics of the reconfigurable metasurface unit cell array 662. Thus, at line 615, one or more ML algorithms may be executed by the metasurface NPU 699 executing machine readable code instructions of an inference engine and the RF performance and power consumption decision module in order to determine how, if at all, to control when a metasurface PMU alters power to any of the plurality of RF antennas within the wireless network or to provide selected bias voltage controls to the reconfigurable metasurface unit cell array 662 to dynamically adjust transmission and reception levels of reflected radiofrequency signals within the radiofrequency environment to optimize wireless network performance.

Output from the ML algorithms selected for execution with the inference engine and the RF performance and power consumption decision module may, therefore, result in adjustments of the operation of the reconfigurable metasurface unit cell array 662, at line 617 when output from the ML algorithms are provided to the metasurface controller 664. For example, the metasurface controller 664, based on the output from the various ML algorithms executed with the inference engine and the RF performance and power consumption decision module by the metasurface NPU 699, may engage in directing whether more power or power reduction in power is provided to one or more on-board antennas at the reconfigurable metasurface unit cell array 662 or, via wireless communication, to other wireless network antennas at wireless network device in the radiofrequency environment. For example, the amount of power provided to the one or more on-board antennas or to another antenna within the wireless network exchanging a radiofrequency signal may be increased in order to increase the signal strength thereby increasing the wireless coverage. This may be done when the ML algorithms have indicated that the SINR is too low or the RSSI value is also too low to support sufficient wireless communication.

In further embodiments, the metasurface controller 664, based on the output from the various ML algorithms executed with the inference engine and the RF performance and power consumption decision module by the metasurface NPU 699 may control bias voltages to the microwave elements of the reconfigurable metasurface unit cell array 662 for adjustment in phase-change or amplitude of capture radiofrequency signals in order to create directional lobes or amplify those EM waves when combined and reflected with received incident radiofrequency signals at the reconfigurable metasurface unit cell array 662. This allows the reconfigurable metasurface unit cell array 662 to amplify reflected EM waves and beamform those EM waves of radiofrequency signals to particular locations in a radiofrequency environment. Again, this beamforming location may be based on an extrapolated AoD of a wireless communication signal to a specific network device in a radiofrequency environment detected by the metasurface controller 664.

Thus, at line 619, the metasurface controller 664 may send antenna power control or activation or deactivation data to the information handling system 600 or any other network device. Additionally, at line 621, those adjustments, such as selected bias voltage phase-shift or amplitude adjustment levels, to the reconfigurable metasurface unit cell array 662 are transmitted to each of the metasurface unit cell subgroups of the reconfigurable metasurface unit cell array 662 in order to engage in creating beamforming patterns, amplitude gain, mitigating interference, or engaging in spatial filtering of reflected radiofrequency signals by the reconfigurable metasurface unit cell array 662 within the radiofrequency environment. This allows for the adaptive enhancement of wireless communications within the wireless networks of a radiofrequency environment.

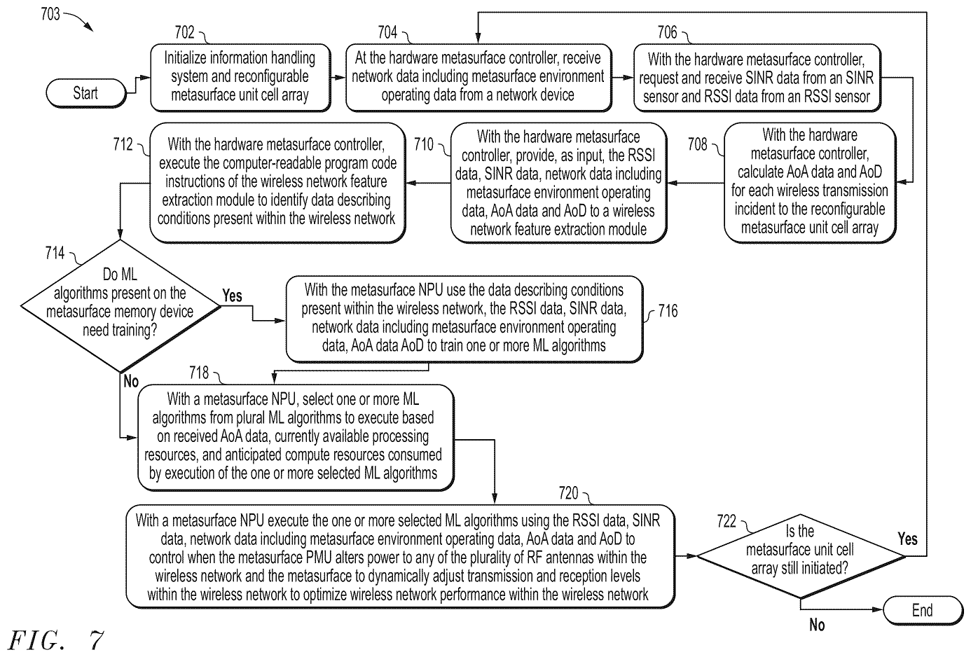

FIG. 7 is a flow diagram of a method 701 of adaptively enhancing a communication system within one or more wireless networks at a reconfigurable metasurface unit cell array in a radiofrequency environment according to another embodiment of the present disclosure. The reconfigurable metasurface unit cell array used in this method may be similar to those reconfigurable metasurface unit cell array described in connection with, for example, FIGS. 1 through 5. The reconfigurable metasurface unit cell array may include a plurality of metasurface unit cells that are individually controlled using a metasurface PMU or other power source, a metasurface controller, and other components as described herein. The metasurface unit cells may be any type that, formed as part of a reconfigurable metasurface unit cell array, may be used to dynamically adjust phase-shifting of received incident radiofrequency signals to form directional lobes and amplitude gain or reduction in reflected radiofrequency signals from the reconfigurable metasurface unit cell array in embodiments herein.

At block 702, the method 701 may include initiating the information handling system and the reconfigurable metasurface unit cell array. In an embodiment, the information handling system may be initiated by a user actuating a power button at the information handling system. Actuation of the power button initializes power to a hardware processor of the information handling system. The user may initialize the reconfigurable metasurface unit cell array by coupling the reconfigurable metasurface unit cell array to a power source (e.g., metasurface PMU 178, FIG. 1) and actuating a button at the reconfigurable metasurface unit cell array. In an embodiment, the reconfigurable metasurface unit cell array may be placed at a location within a radiofrequency environment where wireless radiofrequency transmissions of one or more wireless networks may be reflected off of the surface of the reconfigurable metasurface unit cell array so that the transmission of any given wireless radiofrequency transmission may be extended within the radiofrequency environment or that wireless radiofrequency transmissions may be reflected around objects such as walls within the radiofrequency environment.

At block 704, the method 701 may include receiving, at the hardware metasurface controller, radiofrequency environment data including metasurface environment operating data and wireless network data from one or more wireless network devices in the radiofrequency environment or sensors for radiofrequency environment data at the reconfigurable metasurface unit cell array. In an embodiment, the wireless network data includes various types of metasurface environment operating data such as radiofrequency signal metrics, user prioritizations, data congestion levels, data indicating mobility of wireless devices in the radiofrequency environment, data indicating physical environment challenges of the radiofrequency environment, and data indicating wireless tasks executed by one or more wireless devices in the radiofrequency environment as described herein.

This metasurface environment operating data may include wireless network type data and wireless features within the wireless network that have been identified by the user as describing the environment that the reconfigurable metasurface unit cell array has been placed within. For example, the metasurface environment operating data for the radiofrequency environment may include a list of preferred network devices within a wireless network in one embodiment. For example, where the reconfigurable metasurface unit cell array has been placed within a hospital or a mall, a preferred network device may be a device operated by a doctor or a security guard. These preferred devices may be given higher priority for bandwidth and network resources compared to other network devices. In another example embodiment, the metasurface environment operating data for the radiofrequency environment may include data describing the locations of one or more network devices such as an access point or base station that generally remain in a specific location. In another example embodiment, the metasurface environment operating data for the radiofrequency environment may include data describing dynamically changing wireless condition such as mobile wireless devices operating in a radiofrequency environment, such as drones, robots, laptops, vehicular information handling systems, or mobile device information handling systems. In another example embodiment, the metasurface environment operating data for the radiofrequency environment may include data describing physical environmental challenges such as metallic buildings and machinery, caustic chemical or moist physical environment for difficult circumstances for placement of access points, or vibrational or caustic environments for wireless devices, such as IoT sensing systems, in the physical environment of the radiofrequency environment where the reconfigurable metasurface unit cell array may operate. Additional metasurface environment operating data for the radiofrequency environment may include data describing may include peak hours where network traffic is higher than usual, off-peak hours where network traffic is lower than usual, and other data that the user may provide that anticipates fluctuations in network traffic within the wireless network operating in a radiofrequency environment.

At block 706, the method 701 and includes the metasurface controller requesting and receiving SINR data form an SINR sensor and RSSI data from an RSSI sensor. It is appreciated that the RSSI sensor and SINR sensor may detect and send the RSSI data and SINR data that is associated with each of the wireless transmissions (EM waves) incident to the reconfigurable metasurface unit cell array. In other embodiments, the RSSI data and SINR data that is associated with wireless devices communicating on a radiofrequency signal via the reconfigurable metasurface unit cell array in the radiofrequency environment. In one embodiment, because the RSSI sensor and SINR sensor are formed on the reconfigurable metasurface unit cell array, the RSSI sensor and SINR sensor may detect the RSSI data and SINR data for each wireless transmission in real-time thereby updating the metasurface controller with any changes to each set of RSSI data and SINR data. In other embodiments, wireless devices within the radiofrequency environment may report in real time or periodically RSSI data and SINR data for particular radiofrequency signals extended through the reconfigurable metasurface unit cell array.

At block 708, the method 701 includes calculating AoA data and AoD at the metasurface controller for each wireless radiofrequency signal transmission from wireless devices that is incident to the reconfigurable metasurface unit cell array. As described herein, during operation of the reconfigurable metasurface unit cell array any of a plurality of wireless transmissions may be transmitted such that their radiofrequency signals reach the reconfigurable metasurface unit cell array. In an embodiment, the microwave circuits of each metasurface unit cell of the metasurface unit cell subgroups of the reconfigurable metasurface unit cell array may perform the task of determining this AoA data of any given wireless transmission. In one embodiment, the passive concentric circular resonating antennas of the metasurface unit cells may receive those incident EM waves and transfer the EM wave resonance through a coupler and to the microwave circuit placed below the passive concentric circular resonating antennas of each metasurface unit cell as described in connection with, for example, FIGS. 3A, 3B, and 4. The microwave circuit of each metasurface unit cell act as the AoA detector that can detect this AoA based on plural metasurface unit cells with known spacing between them receiving delayed incident EM waves of a known wavelength. The microwave circuit may send that data for delayed reception of a radiofrequency signal to the metasurface controller for further processing and determination of the AoA and an AoD for return signals to that wireless device in the radiofrequency environment as described herein. In an embodiment, and extrapolated AoD data may also be calculated that describes a physical location of the network device that had transmitted the EM wave towards the reconfigurable metasurface unit cell array.

At block 710, the method 701 also includes sending the SINR data, the RSSI data, the AoA data, and the metasurface environment operating data including the wireless network data and physical environment operating data to the metasurface NPU with the hardware metasurface controller providing this data as input to a wireless network feature extraction module. At block 712, the hardware metasurface controller may execute machine readable code instructions of the wireless network feature extraction module to identify data describing conditions present within the wireless network. Some examples of features extracted from this data may include indications of increases or decreases in network traffic, inclusion within the wireless network of a new network device, prioritization of one or more network devices, and the like.

At block 714, the metasurface NPU may initially determine if one or more ML algorithms need to be trained. Where, for example, the metasurface NPU determines that one or more ML algorithms need to be trained (e.g., new ML algorithm uploaded to the metasurface memory device), the method 701 includes, at block 716, the execution of machine readable code instructions of a ML training module. The ML training module may receive, as input, the RSSI data, the SINR data, the AoA data, and various metasurface environment operating data describing radiofrequency, network, and physical conditions present within the radiofrequency environment that includes wireless network type data and wireless features as described herein in order to train one or more ML algorithms. A plurality of ML algorithms may be made available to the metasurface hardware controller and metasurface NPU that are suited to be optimized to control antennas and the reconfigurable metasurface unit cell array for the radiofrequency, network, and physical conditions present within the radiofrequency environment and to facilitate the wireless devices to conduct tasks wirelessly within the radiofrequency environment.

These available ML algorithms may include any type of ML algorithms including supervised learning algorithms, unsupervised learning algorithms, and reinforcement learning algorithms, deep learning algorithms, recurrent neural network algorithms, CNN algorithms, LSTM network algorithms, and ensemble algorithms that combine one or more of these types of ML algorithms. It is appreciated that these plurality of types of ML algorithms may each be suited to serve a specific purpose or facilitate executing tasks with wireless communications in the radiofrequency environment. For example, some ML algorithms may be better suited for diverse data types and features such as a CNN algorithm that is best suited for visual data while a LSTM network algorithm may be best suited for sequential data. For specialized task requirements at the reconfigurable metasurface unit cell array, a ML algorithm focused on anomaly detection and an ML algorithm focused on resource allocation and real-time decision-making requirements may be used. Still further, in some example embodiments where environmental variability is a concern or is detected within the wireless network, a single ML algorithm may not be flexible enough to adapt to changes within the wireless network and, therefore, an ensemble ML algorithm may be used with the metasurface controller executing machine readable code instructions of a plurality of ML algorithms described above based on those changes in the wireless network. Additionally, some wireless network environments may benefit from modularity, where different ML algorithms being used to handle different aspects of the reconfigurable metasurface unit cell array. This modular approach allows for easier updates and scalability, as new ML algorithms are added or replaced.

Having multiple ML algorithms uploaded to a metasurface memory device and executable by the metasurface controller can provide redundancy thereby improving the reliability of the metasurface controller to detect changes and adaptively enhance communications with the wireless network. If one ML algorithm fails to accommodate for any detected anomalies within the wireless network or performs poorly in enhancing communication with the wireless network for particular tasks or physical environment challenges, other ML algorithms may be executed that can help compensate. Thus, multiple available ML algorithms may be accessed increasing the likelihood that one sufficiently addresses wireless network issues and may be selected for execution thereby ensuring continuous and accurate operation of the reconfigurable metasurface unit cell array 162 within the radiofrequency environment. The ML algorithms may optimize different aspects of the reconfigurable metasurface unit cell array, such that power consumption, signal quality, and data throughput are improved with adjustments of reflected radiofrequency signals by using the trained ML algorithms that may allow for more targeted optimization of reflected radiofrequency signals for given tasks, operations, radiofrequency or network environments, or physical environment challenges that leads to improvement of overall system efficiency. Thus, the execution of the machine readable code instructions of the ML training module by the metasurface controller may cause one or more of these ML algorithms to be trained appropriately such that operation of the reconfigurable metasurface unit cell array within the wireless network enhances communication within that wireless network in the radiofrequency environment.

Where no ML algorithms need to be trained or the ML algorithms have been trained, the metasurface NPU, at block 718 may execute machine readable code instructions of one or more ML algorithms using the SINR data, the RSSI data, the AoA data, and the reconfigurable metasurface operating environment data reflecting radiofrequency, network, and physical conditions present within the radiofrequency environment as input. It is appreciated that the metasurface NPU may execute machine readable code instructions of an inference engine module to select among the plurality of ML algorithms based on a number of factors. Such factors come from the reconfigurable metasurface operating environment data reflecting factors such as detected network congestion, data indicating tasks being performed by wireless devices within the radiofrequency environment, data indicating user prioritizations and congestion levels in wireless networks, data indicating physical environment challenges or limitations of a radiofrequency environment, among other factors. The metasurface NPU executes the machine readable code instructions of the inference engine to select one or more ML algorithms among plural available ML algorithms optimally suited for radiofrequency signal adjustments for such tasks in embodiments herein. In one example, the metasurface NPU may select among the plurality of ML algorithms based on the current processing resources available and the anticipated compute resources consumed by executing the machine readable code instructions of a given ML algorithm. In another example, the metasurface NPU may select a ML algorithm based on the level of training of each of the ML algorithms such that the best trained ML algorithms are selected over yet-untrained or insufficiently trained ML algorithms. In an embodiment, the metasurface NPU may request that new ML algorithms be transmitted to the reconfigurable metasurface unit cell array when the metasurface NPU determines that the ML algorithms stored on the metasurface memory device are not sufficient.

At block 720, therefore, the metasurface NPU may execute the one or more selected ML algorithms using the RSSI data, SINR data, network data including metasurface environment operating data, and AoA data and AoD data as inputs to a selected ML algorithm executing with machine readable code instructions of an inference engine and the RF performance and power consumption decision module in embodiments herein. The execution of the selected ML algorithm or selected combination of ML algorithms of the inference engine and the RF performance and power consumption decision module cause outputs to control when the metasurface PMU alters power to any of the plurality of RF antennas within the wireless network or provides bias voltage to adjust the metasurface to dynamically adjust transmission and reception level directionality and gain for radiofrequency signals in the wireless network to optimize wireless network performance within the radiofrequency environment.

At block 722, the method 701 includes determining if the reconfigurable metasurface unit cell array and information handling system are still initiated. Where the reconfigurable metasurface unit cell array and information handling system are still initiated, the method 701 proceeds to block 704 with the information handling system continuing to monitor for changes in the RSSI data and/or SINR data, network data as well reconfigurable metasurface operating environment data as described herein. Where the reconfigurable metasurface unit cell array and information handling system are no longer initiated, the method 701 may end here.

The processes or steps and aspects of the operation of the embodiments herein, such as those of FIG. 6 or FIG. 7, and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array comprising:
a hardware metasurface controller, a metasurface memory device, and a metasurface power management unit (PMU) to provide power to the hardware metasurface processor and memory device;
the reconfigurable metasurface unit cell array to manipulate electromagnetic (EM) waves of radiofrequency signals incident on a surface of the reconfigurable metasurface unit cell array and received within a radiofrequency environment, the reconfigurable metasurface unit cell array including a plurality of metasurface unit cells each having resonating structures formed on a substrate with a size and spacing between resonating structures to reflect the EM waves of the radiofrequency signals;
the hardware metasurface controller to receive received signal strength indicator (RSSI) data, signal-to-noise-ratio (SINR) data, and metasurface environment operating data including data indicating radiofrequency conditions in the radiofrequency environment;
the hardware metasurface controller to execute machine readable code instructions of feature extraction module to detect wireless network features data associated with wireless communications of the radiofrequency signals;
the hardware metasurface controller executing machine readable code instructions of an inference engine module to, based on the RSSI data, the SINR data, and metasurface environment operating data, select among a plurality of machine learning algorithms for execution with a radiofrequency performance and power consumption decision module; and
the hardware metasurface controller executing machine readable code instructions of the radiofrequency performance and power consumption decision module with the selected machine learning algorithm to adjust phase shift of one or more metasurface unit cells of the reconfigurable metasurface unit cell array to beamform reflected radiofrequency signals in directionality lobes between a transmitting wireless network device and a receiving wireless network device in the radiofrequency environment.

2. The reconfigurable metasurface unit cell array of claim 1 further comprising:
each metasurface unit cell including the resonating structures that are a passive set of concentric antennas formed on a dielectric substrate to receive the radiofrequency signals incident on the surface of the reconfigurable metasurface unit cell array.

3. The reconfigurable metasurface unit cell array of claim 1 further comprising:
the plurality of metasurface unit cells forming a metasurface unit cell subgroup among a plurality of metasurface unit cell subgroups of the reconfigurable metasurface unit cell array, wherein the metasurface unit cell subgroup includes a microwave circuit coupled to each set of resonating structures of each unit cell via a passive coupler; and
the microwave circuit is configured to capture the incident radiofrequency signals from the resonating structures and perform phase modulation of the captured, incident radiofrequency signals with a tunable delay circuit controlled by the hardware metasurface controller.

4. The reconfigurable metasurface unit cell array of claim 1 further comprising:
the metasurface controller to send a bias voltage to a tunable delay circuit to phase shift the captured, incident radiofrequency signal to generate a reflected radiofrequency signal across a plurality of metasurface unit cells for interference patterns with the incoming EM waves of the radiofrequency signal to create directional EM wave radiofrequency transmission or reception lobes within the reflected EM waves of the incident radiofrequency signal.

5. The reconfigurable metasurface unit cell array of claim 1, wherein the hardware metasurface controller to execute machine readable code instructions of feature extraction module to detect wireless network features data including an angle-of-arrival (AoA) and angle-of-departure (AoD) for the transmitting wireless device and the receiving wireless device that defines beamforming of the reflected radiofrequency signals in the directionality lobes and determines interference mitigation and spatial filtering within the radiofrequency environment.

6. The information handling system of claim 1 further comprising:
the hardware metasurface controller to execute machine readable code instructions of a machine learning training module to train the plurality of machine learning algorithms based on the input RSSI data, the SINR data, metasurface environment operating data, and wireless network features data.

7. The reconfigurable metasurface unit cell array of claim 1 further comprising:
the hardware metasurface controller executing machine readable code instructions of the radiofrequency performance and power consumption decision module with the selected machine learning algorithm to control power provided to any of the plurality of radiofrequency antennas within the radiofrequency environment to dynamically adjust transmission and reception levels within a wireless network to optimize wireless network performance within the radiofrequency environment.

8. The reconfigurable metasurface unit cell array of claim 1 further comprising:
the hardware metasurface controller to send a bias voltage to a tunable delay circuit to phase shift the radiofrequency signal capture by the resonating structures formed on the substrate of the metasurface unit cells and coupled to a microwave circuit to generate a reflected radiofrequency signal at one or more metasurface unit cells with interference patterns causing constructive or destructive interference in the reflected radiofrequency signal to beamform reflected EM waves of the reflected radiofrequency signal towards the receiving wireless network devices.

9. The reconfigurable metasurface unit cell array of claim 1 wherein the metasurface environment operating data includes data representing wireless network conditions for a wireless network operating in the radiofrequency environment, data representing tasks executing on the transmitting wireless network device and the receiving wireless network device using the radiofrequency signals, and data representing physical environment conditions relating to placement or use of the transmitting wireless network device and the receiving wireless network device to operate in the radiofrequency environment.

10. A method of adaptively enhancing a communication system within a wireless network at a reconfigurable metasurface unit cell array comprising:
receiving, at a hardware metasurface controller, received signal strength indicator (RSSI) data, signal-to-noise-ratio (SINR) data, and metasurface environment operating data wherein the metasurface environment operating data includes data indicating radiofrequency conditions, wireless network conditions for a wireless network operating in the radiofrequency environment, data representing tasks executing on a transmitting wireless network device and a receiving wireless network device, and data representing physical environment conditions relating to placement or use of a wireless network device to operate in the radiofrequency environment;
executing, via the hardware metasurface controller, machine readable code instructions of an inference engine module to, based on the RSSI data, the SINR data, and metasurface environment operating data, select among a plurality of machine learning algorithms for execution with a radiofrequency performance and power consumption decision module; and
executing, via the hardware metasurface controller, machine readable code instructions of the radiofrequency performance and power consumption decision module with the selected machine learning algorithm to adjust phase shift for radiofrequency signals incident on a surface of one or more metasurface unit cells of the reconfigurable metasurface unit cell array via adjustment to a tunable phase delay circuit in a microwave network of the one or more metasurface unit cells to beamform reflected radiofrequency signals in directionality lobes in a radiofrequency environment, wherein the reconfigurable metasurface unit cell array includes a plurality of metasurface unit cells each having a passive set of concentric antennas formed on a dielectric substrate with a size and spacing between concentric antennas to reflect the EM waves of radiofrequency signals incident on the surface of the reconfigurable metasurface unit cell array and a microwave circuit operatively coupled to the tunable phase delay circuit.

11. The method of claim 10 further comprising:
executing, via the hardware metasurface controller, machine readable code instructions to detect an angle-of-arrival (AoA) and angle-of-departure (AoD) for a transmitting wireless device in the radiofrequency environment based on spacing of a plurality metasurface unit cells that defines beamforming of the reflected radiofrequency signals in the directionality lobes and determines interference mitigation and spatial filtering within the radiofrequency environment.

12. The method of claim 10 further comprising:
executing, via the hardware metasurface controller, machine readable code instructions of the radiofrequency performance and power consumption decision module with the selected machine learning algorithm to control power provided to any of a plurality of radiofrequency antennas within the radiofrequency environment to dynamically adjust transmission and reception levels within a wireless network to optimize wireless network performance within the radiofrequency environment.

13. A reconfigurable metasurface unit cell array comprising:
a hardware metasurface controller, a metasurface memory device, and a metasurface power management unit (PMU) to provide power to the hardware metasurface processor and memory device;
the reconfigurable metasurface unit cell array to manipulate electromagnetic (EM) waves of radiofrequency signals incident on a surface of the reconfigurable metasurface unit cell array and received within a radiofrequency environment, the reconfigurable metasurface unit cell array including a plurality of metasurface unit cells each having resonating structures formed on a substrate with a size and spacing between resonating structures to reflect the EM waves of the radiofrequency signals and a microwave circuit operatively coupled to a microwave circuit network;
the hardware metasurface controller to receive received signal strength indicator (RSSI) data, signal-to-noise-ratio (SINR) data, and metasurface environment operating data wherein the metasurface environment operating data includes data indicating radiofrequency conditions, wireless network conditions for a wireless network operating in the radiofrequency environment, data representing tasks executing on a transmitting wireless network device and a receiving wireless network device, and data representing physical environment conditions relating to placement or use of the transmitting wireless network device and the receiving wireless network device to operate in the radiofrequency environment;
the hardware metasurface controller executing machine readable code instructions of an inference engine module to, based on the RSSI data, the SINR data, and metasurface environment operating data, select among a plurality of machine learning algorithms for execution with a radiofrequency performance and power consumption decision module; and
the hardware metasurface controller executing machine readable code instructions of the radiofrequency performance and power consumption decision module with the selected machine learning algorithm to adjust phase shift of one or more metasurface unit cells of the reconfigurable metasurface unit cell array via adjustment to a tunable phase delay circuit in the microwave network to beamform reflected radiofrequency signals in directionality lobes between the transmitting wireless network device and the receiving wireless network device in the radiofrequency environment.

14. The reconfigurable metasurface unit cell array of claim 13 further comprising:
each metasurface unit cell including the resonating structures that are a passive set of concentric antennas formed on a dielectric substrate to receive the radiofrequency signals incident on the surface of the reconfigurable metasurface unit cell array.

15. The reconfigurable metasurface unit cell array of claim 14 further comprising:
the plurality of metasurface unit cells forming a metasurface unit cell subgroup among a plurality of metasurface unit cell subgroups of the reconfigurable metasurface unit cell array, wherein the metasurface unit cell subgroup includes a microwave circuit coupled to each set of concentric antennas of each unit cell via a passive coupler; and
the microwave circuit is configured to capture the incident radiofrequency signals from the concentric antennas and perform phase modulation of the captured, incident radiofrequency signals with a tunable delay circuit controlled by the hardware metasurface controller.

16. The reconfigurable metasurface unit cell array of claim 13 further comprising:
the metasurface controller to send a bias voltage to a tunable delay circuit to phase shift the captured, incident radiofrequency signal to generate a reflected radiofrequency signal across a plurality of metasurface unit cells for interference patterns with the incoming EM waves of the radiofrequency signal to create directional EM wave radiofrequency transmission or reception lobes within the reflected EM waves of the incident radiofrequency signal.

17. The reconfigurable metasurface unit cell array of claim 13, wherein the hardware metasurface controller executes machine readable code instructions to detect an angle-of-arrival (AoA) and angle-of-departure (AoD) for the transmitting wireless device and the receiving wireless device that defines beamforming of the reflected radiofrequency signals in the directionality lobes and determines interference mitigation and spatial filtering within the radiofrequency environment.

18. The information handling system of claim 13 further comprising:
the hardware metasurface controller to execute machine readable code instructions of a machine learning training module to train the plurality of machine learning algorithms based on the input RSSI data, the SINR data, and metasurface environment operating data.

19. The reconfigurable metasurface unit cell array of claim 13 further comprising:
the hardware metasurface controller executing machine readable code instructions of the radiofrequency performance and power consumption decision module with the selected machine learning algorithm to control power provided to any of the plurality of radiofrequency antennas within the radiofrequency environment to dynamically adjust transmission and reception levels within a wireless network to optimize wireless network performance within the radiofrequency environment.

20. The reconfigurable metasurface unit cell array of claim 13 further comprising:
the hardware metasurface controller to send a bias voltage to a tunable delay circuit to phase shift the radiofrequency signal capture by the resonating structures formed on the substrate of the metasurface unit cells and coupled to a microwave circuit to generate a reflected radiofrequency signal at one or more metasurface unit cells with interference patterns causing constructive or destructive interference in the reflected radiofrequency signal to beamform reflected EM waves of the reflected radiofrequency signal towards the receiving wireless network devices.
